(19) United States
(12) Patent Application Publication
(10) Pub. No.: US 2026/0267896 A1
(43) Pub. Date: Sep. 10, 2026

(54) SERVER FOR PROVIDING RELEVANT CONTEXT INFORMATION IN REAL TIME WHILE SENDING AND RECEIVING CHAT MESSAGES WITH USER DEVICE AND METHOD FOR OPERATION THEREOF

(71) Applicant: Yanolja NEXT Co., Ltd., Seoul (KR)

(72) Inventors: Bo Kyung HUH, Seoul (KR); Su Hyun KANG, Paju-si (KR); Geon KIM, Seoul (KR); Sang Hoon HAN, Seoul (KR); Eun Sue CHOI, Goyang-si (KR); Seung Duk KIM, Seoul (KR)

(73) Assignee: Yanolja NEXT Co., Ltd., Seoul (KR)

(21) Appl. No.: 19/663,708

(22) Filed: Apr. 30, 2026

Related U.S. Application Data
(63) Continuation of application No. PCT/KR2024/016371, filed on Oct. 25, 2024.

(30) Foreign Application Priority Data
Oct. 31, 2023 (KR) 10-2023-0148563
Dec. 11, 2023 (KR) 10-2023-0178994
Jan. 12, 2024 (KR) 10-2024-0005561
May 31, 2024 (KR) 10-2024-0071792

(51) Int. Cl. G06F 16/338; G06F 3/0481; G06F 40/30

(52) U.S. Cl. CPC G06F 16/338; G06F 40/30; G06F 3/0481; G06F 2203/04803

(57) ABSTRACT

The present disclosure relates to a server for providing relevant context information in real-time while transmitting and receiving chat messages with a user device using an intelligent agent may include a communication module and a processor. The processor may be configured to execute instructions to cause the user device to display at least one chat message transmitted and received with a large language model (LLM) based intelligent agent on a chat window screen, in response to identifying first context information related to a travel itinerary from a first user message received from the user device, cause the user device to display the first context information on a travel itinerary display window screen, and output a first agent message including at least a portion of the first context information and first search result information corresponding to a specific query to the chat window screen through the intelligent agent.

### CROSS-REFERENCE TO RELATED APPLICATION

This application is a Continuation Application of International Application No. PCT/KR2024/016371, filed Oct. 23, 2024, which claim for priority under 35 U.S.C. § 119 is made to Korean Patent Application No. 10-2023-0148563, filed on Oct. 31, 2023, Korean Patent Application No. 10-2023-0178994, filed on Dec. 11, 2023, Korean Patent Application No. 10-2024-0005561, filed on Jan. 12, 2024, and Korean Patent Application No. 10-2024-0071792, filed on May 31, 2024. The disclosures of the above-listed applications are hereby incorporated by reference herein in their entirety.

### BACKGROUND

### 1. Field

Various embodiments of the present disclosure relate to a server for providing relevant context information in real time while transmitting and receiving chat messages with a user device, and an operation method thereof.

Various embodiments of the present disclosure relate to a server for providing a package travel product while transmitting and receiving chat messages with a user device through an intelligent agent, and an operation method thereof.

Various embodiments of the present disclosure relate to an electronic device for generating training data to be used for training a large language model, and an operation method thereof.

### 2. Description of Related Art

Recently, with the advancement of technologies in the field of artificial intelligence, particularly in the field of natural language understanding, there is a gradual increase in the development and utilization of conversational AI agent systems that allow a user to operate a machine in a more human-friendly manner—for example, through natural language in the form of voice and/or text- and obtain desired services from the machine, moving away from traditional machine-oriented command input/output methods.

Accordingly, in various fields including, but not limited to, online counseling centers or online shopping malls, users are now able to request desired services from conversational AI agent systems and obtain desired results therefrom through natural language dialogue in the form of voice and/or text.

### SUMMARY

A server according to the present disclosure may provide a service that allows a user to plan a travel itinerary in a conversational manner and receive recommendations for personalized travel products by combining a large language model (LLM), travel-related information, and user interface (UI) technologies.

A server according to the present disclosure may provide a package travel product by allowing a user device to check a package travel product in which travel products are freely combined and reasonably determining a discount price therefor while transmitting and receiving chat messages through an intelligent agent.

An electronic device according to the present disclosure may provide a method for generating virtual text data specialized for various domains while being suitable for training a large language model by using rules for generating training data based on probability and states, and for automatically expanding training data using the large language model.

According to various embodiments, a server for providing relevant context information in real-time while transmitting and receiving chat messages with a user device using an intelligent agent may include a communication module and a processor. The processor may be configured to execute instructions to cause the user device to display at least one chat message transmitted and received with a large language model (LLM) based intelligent agent on a chat window screen, in response to identifying first context information related to a travel itinerary from a first user message received from the user device, cause the user device to display the first context information on a travel itinerary display window screen, and output a first agent message including at least a portion of the first context information and first search result information corresponding to a specific query to the chat window screen through the intelligent agent, while causing the user device to display at least one first object for second context information corresponding to the first search result information on a context display window screen.

According to various embodiments, a method of a server for providing relevant context information in real-time while transmitting and receiving chat messages with a user device using an intelligent agent may include causing the user device to display at least one chat message transmitted and received with a large language model (LLM) based intelligent agent on a chat window screen, causing, in response to identifying first context information related to a travel itinerary from a first user message received from the user device, the user device to display the first context information on a travel itinerary display window screen, and outputting a first agent message including at least a portion of the first context information and first search result information corresponding to a specific query to the chat window screen through the intelligent agent, while causing the user device to display at least one first object for second context information corresponding to the first search result information on a context display window screen.

According to various embodiments, a computer program product may include one or more programs configured to be executed by one or more processors of a computer system. The one or more programs may include instructions for causing the user device to display at least one chat message transmitted and received with a large language model (LLM) based intelligent agent on a chat window screen, in response to identifying first context information related to a travel itinerary from a first user message received from the user device, causing the user device to display the first context information on a travel itinerary display window screen, and outputting a first agent message including at least a portion of the first context information and first search result information corresponding to a specific query to the chat window screen through the intelligent agent, while causing the user device to display at least one first object for second context information corresponding to the first search result information on a context display window screen.

According to various embodiments, a server for providing a package travel product while transmitting and receiving chat messages with a user device through an intelligent agent may include a communication module and a processor. The processor may be configured to execute instructions to cause the user device to display at least one chat message transmitted to and received from an intelligent agent based on a large language model (LLM) on a chat window screen, identify a request for generating a package travel product, which is a combination of at least two travel products, from a user message received from the user device, determine price information of the package travel product by using first context information related to a travel itinerary, and cause the user device to display an agent message including the price information of the package travel product on the chat window screen through the intelligent agent.

According to various embodiments, a method of a server for providing a package travel product while transmitting and receiving chat messages with a user device through an intelligent agent may include: causing the user device to display at least one chat message transmitted to and received from an intelligent agent based on a large language model (LLM) on a chat window screen; identifying a request for generating a package travel product, which is a combination of at least two travel products, from a user message received from the user device; determining price information of the package travel product by using first context information related to a travel itinerary; and causing the user device to display an agent message including the price information of the package travel product on the chat window screen through the intelligent agent.

According to various embodiments, a computer program product may include one or more programs configured to be executed by one or more processors of a computer system. The one or more programs may include instructions for: causing a user device to display at least one chat message transmitted to and received from an intelligent agent based on a large language model (LLM) on a chat window screen; identifying a request for generating a package travel product, which is a combination of at least two travel products, from a user message received from the user device; determining price information of the package travel product by using first context information related to a travel itinerary; and causing the user device to display an agent message including the price information of the package travel product on the chat window screen through the intelligent agent.

According to various embodiments, an electronic device for generating training data to be used for training a large language model may include a display and a processor. The processor may be configured to create at least one node among a storage node, a switch node, a branch node, and an output node by using an application for generating the training data, generate a node flow in which transition relationships between the at least one node and variable-related values for each of the nodes are set, and generate, in response to a request for generating the training data, the training data according to a result of executing the node flow, wherein the training data may include prompt data corresponding to a virtual user message and completion data corresponding to a virtual agent message.

According to various embodiments, an operation method of an electronic device for generating training data to be used for training a large language model may include: creating at least one node among a storage node, a switch node, a branch node, and an output node by using an application for generating the training data, generating a node flow in which transition relationships between the at least one node and variable-related values for each of the nodes are set; and generating, in response to a request for generating the training data, the training data according to a result of executing the node flow, wherein the training data may include prompt data corresponding to a virtual user message and completion data corresponding to a virtual agent message.

According to various embodiments, a computer program product may include one or more programs configured to be executed by one or more processors of a computer system. The one or more programs may include instructions for: creating at least one node among a storage node, a switch node, a branch node, and an output node by using an application for generating training data to be used for training a large language model; generating a node flow in which transition relationships between the at least one node and variable-related values for each of the nodes are set; and generating, in response to a request for generating the training data, the training data according to a result of executing the node flow, wherein the training data may include prompt data corresponding to a virtual user message and completion data corresponding to a virtual agent message.

The present disclosure may provide an effect of smoothly conducting a conversation with a user through a large language model-based intelligent agent while providing relevant context information related to the conversation in real time through an intuitive UI, thereby providing information suitable for the user's request and enhancing user convenience through content display that is easy for the user to recognize.

The present disclosure may provide an effect of encouraging a user's desire for travel and increasing the cost rationality of a travel itinerary by determining appropriate discount price information when the user requests a package travel product by freely combining travel products during a conversation with an intelligent agent.

Since a large amount of user messages and agent messages configured as pairs are required for training a large language model, the present disclosure may provide an effect of increasing the training efficiency of the large language model by automatically generating a large amount of training data configured with virtual user messages and virtual agent messages without requiring the user to directly input user messages or agent messages.

### BRIEF DESCRIPTION OF THE DRAWINGS

FIG. 1 is a block diagram of a user device and a server according to various embodiments of the present disclosure.

FIG. 2 is a flowchart illustrating an operation in which a server provides relevant context information in real time during a conversation with a user device through an intelligent agent according to various embodiments.

FIGS. 3A to 3D are diagrams illustrating a first embodiment in which a server causes an object for context information to be displayed in real time during a conversation with a user device through an intelligent agent according to various embodiments.

FIGS. 4A to 4D are diagrams illustrating a second embodiment in which a server causes an object for context information to be displayed in real time during a conversation with a user device through an intelligent agent according to various embodiments.

FIGS. 5A to 5G are diagrams illustrating an embodiment in which a server causes an object for context information to be changed and displayed according to a change in the content of a user message during a conversation with a user device through an intelligent agent according to various embodiments.

FIG. 6 is a diagram illustrating an embodiment in which a server generates a user message to be input to an intelligent agent based on user input confirmed through a context display window screen according to various embodiments.

FIG. 7 is a diagram illustrating an embodiment in which a server provides a plurality of contents through a context display window screen divided into a plurality of areas according to various embodiments.

FIG. 8 is a flowchart illustrating an operation in which a server provides a package travel product according to various embodiments.

FIGS. 9A to 9C illustrate a first embodiment in which a server provides a package travel product according to various embodiments.

FIGS. 10A to 10B illustrate a second embodiment in which a server provides a package travel product according to various embodiments.

FIG. 11 is a flowchart illustrating an operation in which an electronic device generates training data to be used for training a large language model according to various embodiments.

FIG. 12 is a diagram illustrating GUIs for each type of node used for generating training data according to various embodiments.

FIG. 13 is a diagram illustrating a node flow object in which a node flow is implemented in a GUI form according to various embodiments.

FIG. 14 is a diagram illustrating a training data set according to various embodiments.

FIG. 15A is a diagram illustrating a node flow object for generating training data for a translation LLM according to various embodiments.

FIG. 15B is a diagram illustrating an example of a training data entry for a translation LLM generated by the node flow object of FIG. 15A according to various embodiments.

FIG. 16A is a diagram illustrating a node flow object for generating training data for a summarization LLM according to various embodiments.

FIG. 16B is a diagram illustrating an example of a training data entry for a summarization LLM generated by the node flow object of FIG. 16A according to various embodiments.

### DETAILED DESCRIPTION OF THE PREFERRED EMBODIMENT

Hereinafter, various embodiments of the present document will be described with reference to the accompanying drawings. The embodiments and the terms used therein are not intended to limit the technology described in the present document to specific embodiments, and should be understood to include various modifications, equivalents, and/or alternatives of the embodiments.

In connection with the description of the drawings, similar reference numerals may be used for similar components. The singular forms “a,” “an,” and “the” may include the plural forms as well, unless the context clearly indicates otherwise.

In the present document, expressions such as “A or B” or “at least one of A and/or B” may include all possible combinations of the items listed together.

Expressions such as “first,” “second,” “primary,” or “secondary” may modify corresponding components regardless of the order or importance, and are used only to distinguish one component from another component and do not limit the components. When a component (e.g., a first component) is referred to as being “(functionally or communicatively) connected” or “coupled” to another component (e.g., a second component), the component may be directly connected to the other component or connected through another component (e.g., a third component).

In the present document, the expression “configured to (or set to)” may be used interchangeably with, for example, “suitable for,” “having the capacity to,” “designed to,” “adapted to,” “made to,” or “capable of” in hardware or software according to the context. In some situations, the expression “a device configured to” may mean that the device is “capable of” performing a function together with other devices or components. For example, the phrase “a processor configured (or set) to perform A, B, and C” may mean a dedicated processor (e.g., an embedded processor) for performing the corresponding operations, or a generic-purpose processor (e.g., a CPU or an application processor) capable of performing the corresponding operations by executing one or more software programs stored in a memory device.

A user device or an electronic device according to various embodiments of the present document may include, for example, at least one of a smartphone, a tablet PC, a desktop PC, a laptop PC, a netbook computer, a workstation, or a server.

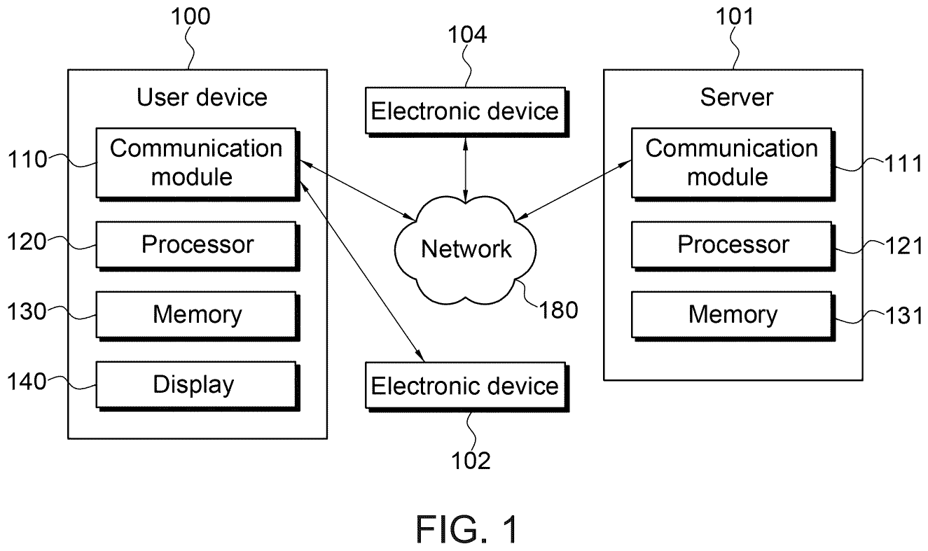

Referring to FIG. 1, a user device 100 and a server 101 in various embodiments are described. The user device 100 may include a communication module 110, a processor 120, a memory 130, and a display 140. In some embodiments, the user device 100 may omit at least one of the components or may further include other components.

The communication module 110 may establish communication between, for example, the user device 100 and an external device (e.g., a first external electronic device 102, a second external electronic device 104, or the server 101). For example, the communication module 110 may be connected to a network 180 through wireless communication or wired communication to communicate with the external device (e.g., the second external electronic device 104 or the server 101).

The wireless communication may include cellular communication using at least one of, for example, LTE, LTE-A (LTE Advance), CDMA (code division multiple access), WCDMA (wideband CDMA), UMTS (universal mobile telecommunications system), WiBro (Wireless Broadband), or GSM (Global System for Mobile Communications). According to an embodiment, the wireless communication may include at least one of, for example, WiFi (wireless fidelity), Bluetooth, Bluetooth Low Energy (BLE), Zigbee, NFC (near field communication), magnetic secure transmission (MST), radio frequency (RF), or body area network (BAN). According to an embodiment, the wireless communication may include a GNSS (global navigation satellite system). The GNSS may be, for example, GPS (Global Positioning System), Glonass (Global Navigation Satellite System), Beidou Navigation Satellite System (hereinafter, “Beidou”), or Galileo (the European global satellite-based navigation system). Hereinafter, in the present document, “GPS” may be used interchangeably with “GNSS.” The wired communication may include at least one of, for example, USB (universal serial bus), HDMI (high definition multimedia interface), RS-232 (recommended standard 232), power line communication (PLC), or POTS (plain old telephone service). The network 180 may include a telecommunication network, for example, at least one of a computer network (e.g., LAN or WAN), the Internet, or a telephone network.

The processor 120 may include one or more of a central processing unit (CPU), an application processor (AP), or a communication processor (CP). The processor 120 may, for example, execute calculations or data processing related to control and/or communication of at least one other component of the user device 100.

The memory 130 may include volatile and/or non-volatile memory. The memory 130 may, for example, store instructions or data related to at least one other component of the user device 100.

The display 140 may include, for example, a liquid crystal display (LCD), a light-emitting diode (LED) display, an organic light-emitting diode (OLED) display, a micro-electromechanical systems (MEMS) display, or an electronic paper display. The display 140 may, for example, display various types of content (e.g., text, images, videos, icons, and/or symbols) to a user. The display 140 may include a touch screen and may receive, for example, a touch, gesture, proximity, or hovering input using an electronic pen or a part of the user's body.

Each of the first and second external electronic devices 102 and 104 may be a device of the same type as or a different type from the user device 100. According to various embodiments, all or some of the operations executed in the user device 100 may be executed in one or more other electronic devices (e.g., the electronic devices 102 and 104 or the server 101). According to an embodiment, when the user device 100 should perform a certain function or service automatically or in response to a request, the user device 100 may request at least a part of the functions associated therewith from another device (e.g., the electronic device 102 or 104 or the server 101) instead of or in addition to executing the function or service by itself. The other electronic device (e.g., the electronic device 102 or 104 or the server 101) may execute the requested function or the additional function and transfer the result to the user device 100. The user device 100 may provide the requested function or service by processing the received result as it is or additionally. For this purpose, for example, cloud computing, distributed computing, or client-server computing technology may be used.

The server 101 may include a communication module 111, a processor 121, and a memory 131. In some embodiments, the server 101 may omit at least one of the components or may further include other components. The communication module 111, the processor 121, and the memory 131 may perform the same functions as the communication module 110, the processor 120, and the memory 130 in the user device 100, respectively.

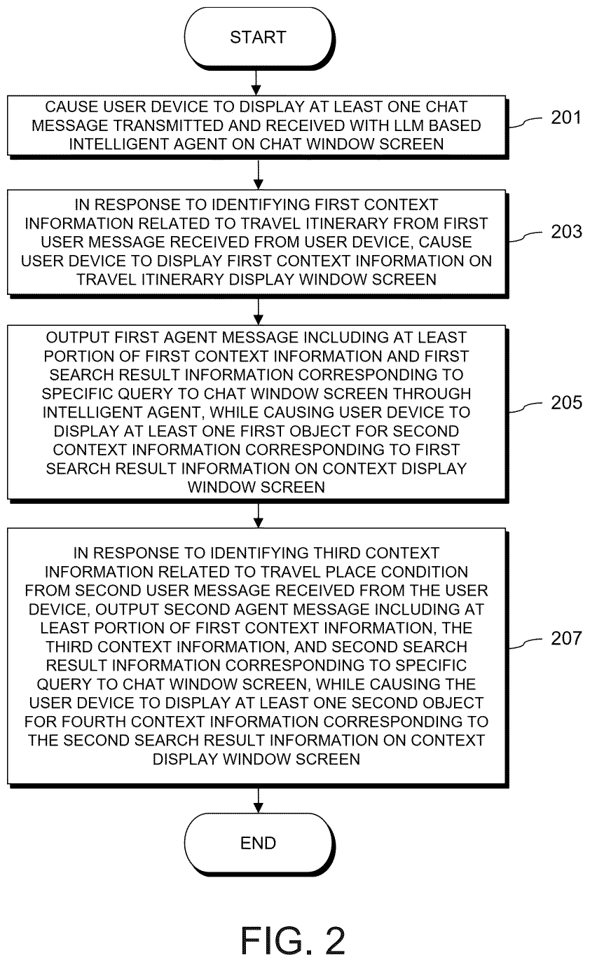

FIG. 2 is a flowchart illustrating an operation in which a server (e.g., the server 101 of FIG. 1) provides relevant context information in real time during a conversation with a user device through an intelligent agent according to various embodiments.

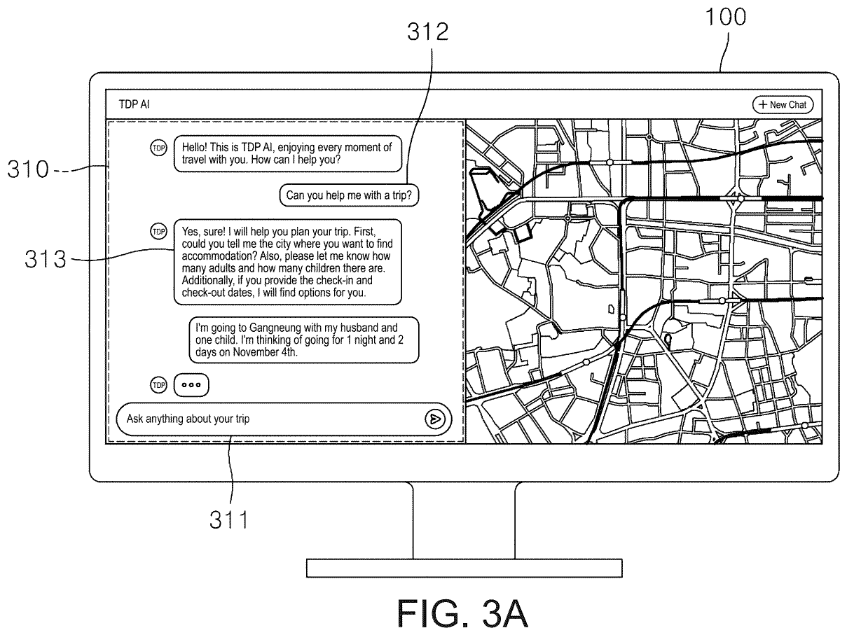

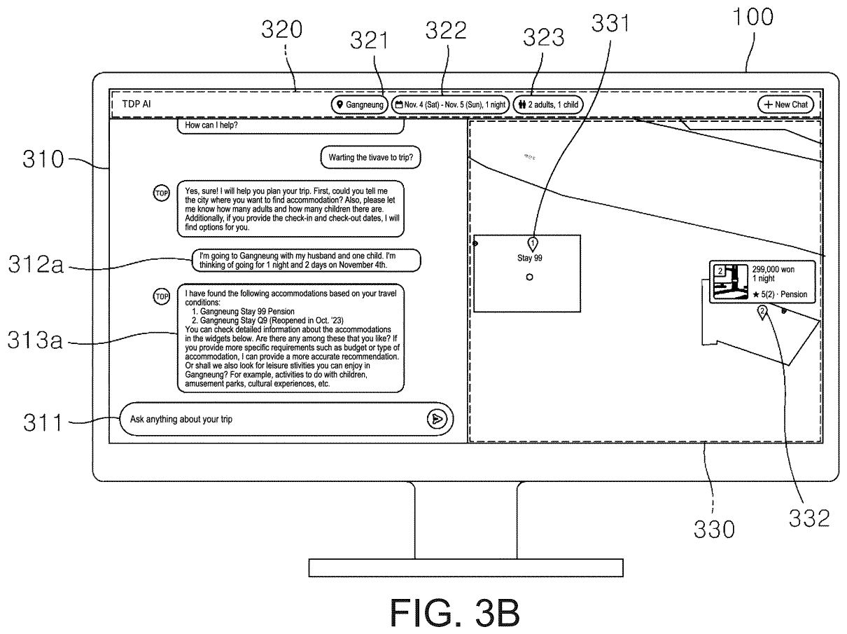

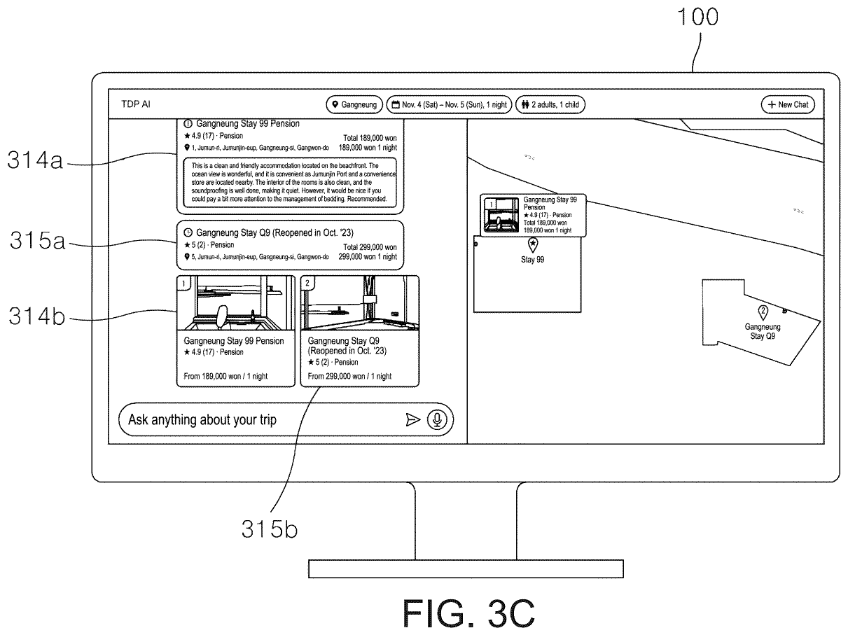

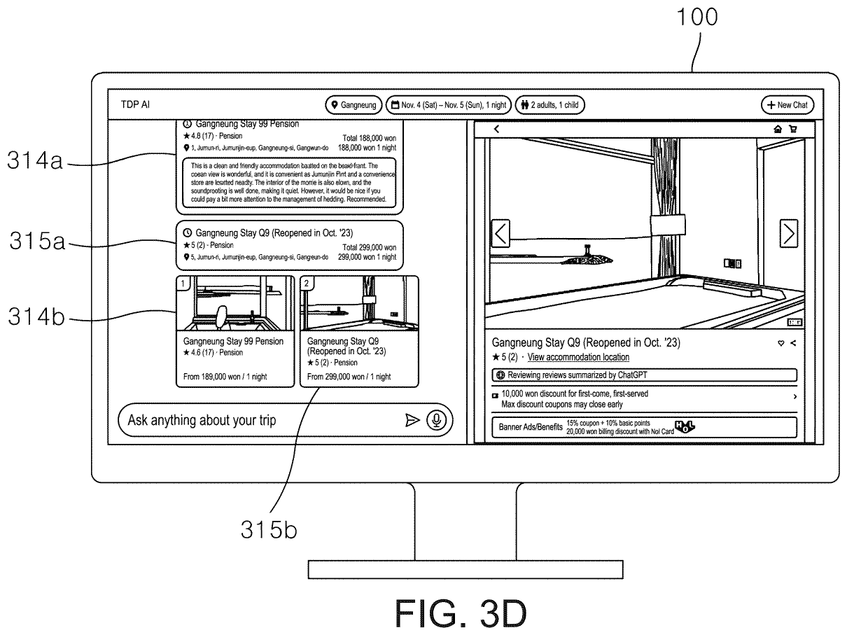

FIGS. 3A to 3D are diagrams illustrating a first embodiment in which a server causes an object for context information to be displayed in real time during a conversation with a user device (e.g., the user device 100 of FIG. 1) through an intelligent agent according to various embodiments.

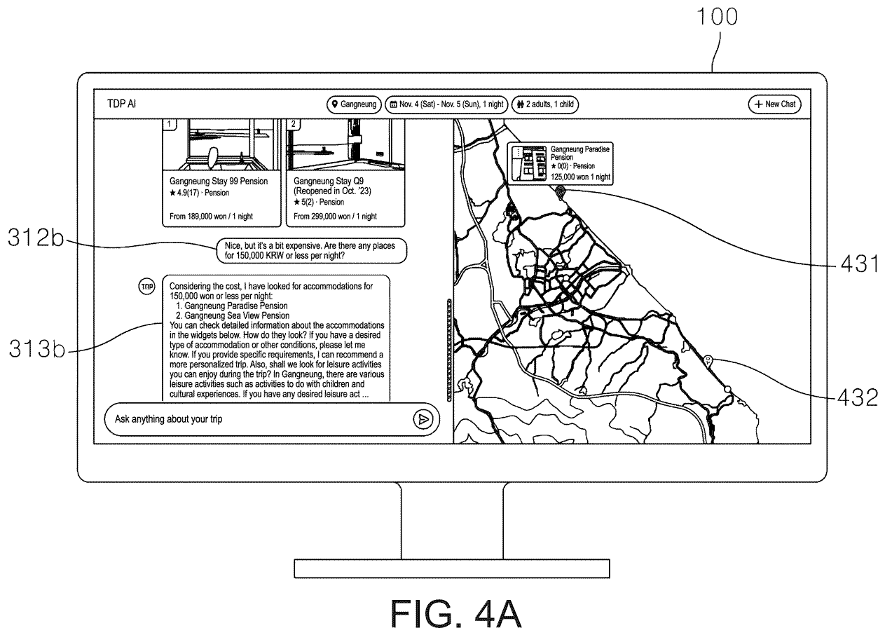

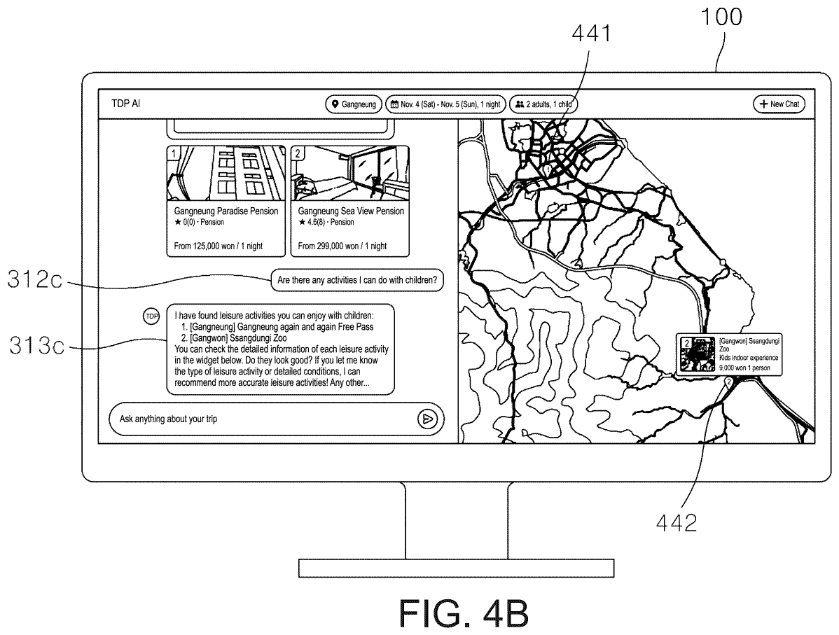

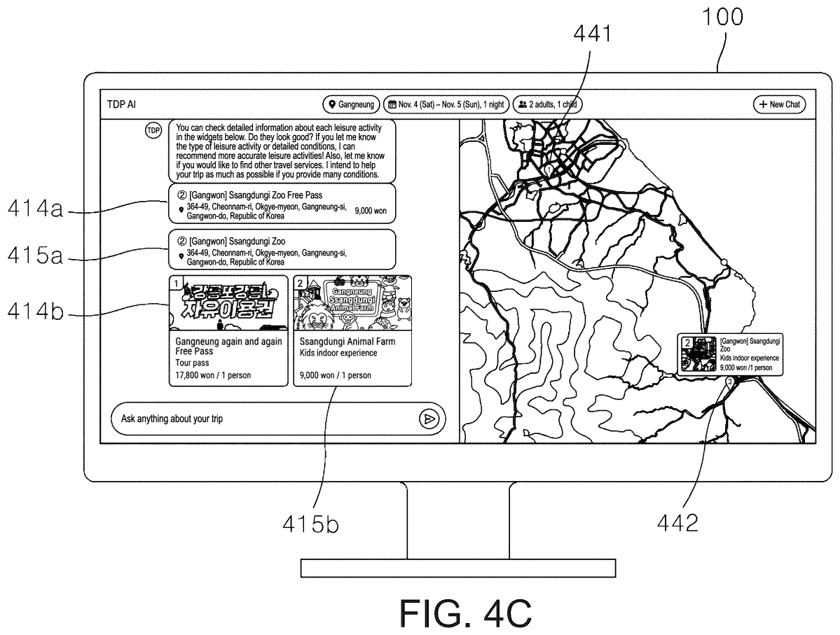

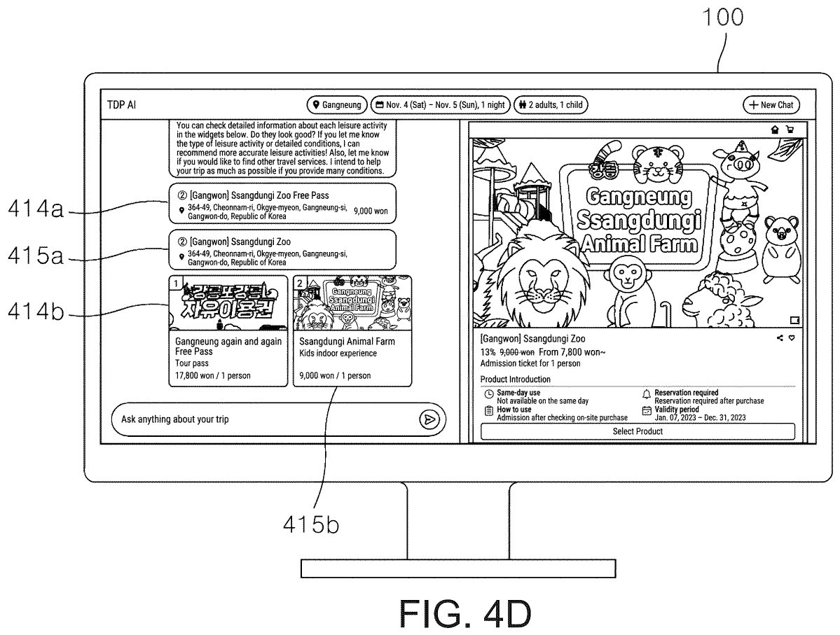

FIGS. 4A to 4D are diagrams illustrating a second embodiment in which a server causes an object for context information to be displayed in real time during a conversation with a user device through an intelligent agent according to various embodiments.

According to various embodiments, the server 101 may operate an application composed of a plurality of execution screens or a website composed of a plurality of web pages. The server 101 may communicate with a user device (e.g., the electronic devices 100, 102, and 104 of FIG. 1) (e.g., a PC, a laptop, a smartphone, etc.) through networks 162 and 164, process requests received from the user device 100 regarding an application or web page, and transmit requested information to the user device 100. The server 101 may transmit source code to the user device 100 to enable the display of each execution screen of a dedicated application or website providing related context information while exchanging conversations with the user device 100 through an intelligent agent. The user device 100 may receive the source code and display the execution screen requested by the user of the user device 100 through the dedicated application or a web browser. According to an embodiment, the server 101 may include the same types of components as the electronic device 100 of FIG. 1. According to an embodiment, configurations referred to as the user device 100 in the present disclosure may refer to a user account accessing a platform provided by the server 101 through the corresponding user device.

In operation 201, according to various embodiments, the server 101 (e.g., the processor 121 of FIG. 1) may cause the user device 100 to display at least one chat message transmitted to and received from an intelligent agent based on a large language model (LLM) on a chat window screen.

According to an embodiment, the large language model may include, for example, a transformer-based neural network model and may be used for (1) natural language understanding (NLU) to understand the meaning of sentences and perform tasks such as keyword extraction, sentiment analysis, and information retrieval, (2) natural language generation (NLG) to generate natural language in various forms such as sentences, paragraphs, summaries, and translations, (3) a query-response field to generate answers to given questions, (4) a machine translation field to perform translation tasks between multiple languages, and (5) a text summarization field to increase the value of information by concisely summarizing long texts. The large language model may include various language models that can be easily implemented by those skilled in the art in addition to the aforementioned examples.

According to an embodiment, the server 101 may execute an intelligent agent at the request of the user device 100 and may transmit and receive chat messages with the user device 100 through the intelligent agent. For example, referring to FIG. 3A, the server 101 may cause the user device 100 to display a chat window screen 310 that displays chat messages between the user device 100 and the intelligent agent through a display 140. According to an embodiment, the intelligent agent linked with the large language model may input a user message obtained from the user device 100 into the large language model to generate an agent message processed in the form of an answer to the user message. The server 101 may transmit the agent message to the user device 100 to display chat messages between the user device 100 and the intelligent agent on the chat window screen 310 of the user device 100. For example, referring to FIG. 3A, the chat window screen 310 may include a text input field 311 for receiving text from a user, and the server 101 may cause the user message 312 input by the user through the text input field 311 and the agent message 313 responded by the intelligent agent to the chat message 312 to be displayed through the chat window screen 310.

According to an embodiment, the counterpart transmitting and receiving chat messages with the user device 100 may be not only an intelligent agent but also another user device 104 (e.g., another general user or an employee in charge of customer service (CS) for an application operated by the server 101), which is merely an example and not limited thereto. According to an embodiment, the server 101 may perform an operation of displaying related context information according to the present disclosure by analyzing chat messages between user devices 100 and 104.

In operation 203, according to various embodiments, the server 101 (e.g., the processor 121 of FIG. 1) may cause the user device 100 to display first context information on a travel itinerary display window screen in response to identifying the first context information related to a travel itinerary from a first user message received from the user device 100.

According to an embodiment, the server 101 may identify the first context information related to a travel itinerary from the first user message. According to an embodiment, the first context information related to the travel itinerary may include at least one of travel region information, travel date information, or travel personnel information. The travel region information may include continent-specific, country-specific, city-specific, administrative district-specific information registered in the server 101, or a combination thereof. The travel date information may include at least one of travel date information (e.g., 2023.M1.D1~M2.D2), travel duration information corresponding to the travel date information (e.g., m nights or m nights and n days), travel day-of-the-week information corresponding to the travel date information (e.g., travel start day, travel end day, days during the travel period), or travel month information belonging to the travel date information (e.g., at least one of January to December). The travel personnel information is information regarding the number of travelers and may include, for example, information regarding the age and number of travelers, such as “n adults” and “m children.” The aforementioned examples of first context information related to a travel itinerary are merely examples and are not limited thereto; the types/items thereof may be freely changed by the settings of the user of the user device 100 or the administrator of the server 101.

According to an embodiment, the server 101 may cause the user device 100 to display the first context information on the travel itinerary display window screen in response to identifying the first context information through the intelligent agent. For example, referring to FIG. 3B, the server 101 may identify, as the first context information, travel region information 321 (e.g., Gangneung), travel date information 322 (e.g., November 4 (Sat)-November 5 (Sun), 1 night), and travel personnel information 323 (e.g., 2 adults, 1 child) from a first user message 312a (e.g., “I'm going to Gangneung with my husband and one child. I'm thinking of going for 1 night and 2 days on November 4th”), and cause the user device 100 to display the first context information on the travel itinerary display window screen 320.

In operation 205, according to various embodiments, the server 101 (e.g., the processor 121 of FIG. 1) may output a first agent message including at least a portion of the first context information and first search result information corresponding to a specific query to the chat window screen, while causing the user device 100 to display at least one first object for second context information corresponding to the first search result information on a context display window screen.

According to an embodiment, the server 101 may identify the first search result information determined by the intelligent agent based on at least a portion of the first context information and a specific query. According to an embodiment, the intelligent agent may obtain the first search result information by searching a specific query related to the current conversation session and at least a portion of the first context information from a database linked with the large language model (e.g., a travel information-related DB) or a large language model trained using the database. The database storing travel-related information may be implemented in the form of a component inside the server 101 or as a separate component outside the server 101. Specifically, referring to FIG. 3B, the intelligent agent may identify first search result information (e.g., first accommodation information, second accommodation information) using travel region information (e.g., Gangneung) of the first context information and a specific query (e.g., accommodation information) regarding the current conversation session. Here, the specific query may represent a conversation topic (i.e., a search keyword) that the intelligent agent intends to identify in the conversation with the user device 100 and may be determined by settings of the intelligent agent or by an analysis result of a message obtained from the user device 100. According to an embodiment, the specific query may be transportation information, accommodation information, tourist spot information, restaurant information, tour information, or ticket information. For example, the specific query in FIGS. 3A to 3D may be “accommodation information.”

According to an embodiment, the server 101 may generate a first agent message including the first search result information as a response message obtained by inputting the first user message into the large language model through the intelligent agent. For example, referring to FIG. 3B, the server 101 may cause the user device 100 to display the first agent message 313a including the first search result information on the chat window screen 310.

According to an embodiment, the second context information may include at least one of location information (e.g., address information), web link information (e.g., web page URL), or app link information (e.g., app page URL) corresponding to the first search result information. According to an embodiment, the second context information corresponding to the first search result information may further include application execution information for representing the second context information. For example, the second context information may include address information and map app execution information. As another example, the second context information may include web link information and web browser execution information. The aforementioned examples of the second context information are merely examples and are not limited thereto; the types/items thereof may be freely changed by the settings of the administrator of the server 101.

According to an embodiment, the server 101 may cause the user device 100 to display at least one first object for the second context information on the context display window screen while causing the user device 100 to display the first agent message on the chat window screen 310 through the intelligent agent. For example, referring to FIG. 3B, the server 101 may cause the user device 100 to display the first agent message 313a on the chat window screen 310 through the intelligent agent while executing a map app on the context display window screen 330 to display location indicators 331 and 332 for the second context information (e.g., location information of the first accommodation and location information of the second accommodation).

According to an embodiment, the server 101 may cause the user device 100 to display at least one additional message supporting the first agent message through the intelligent agent. For example, referring to FIGS. 3B and 3C, the server 101 may cause the user device 100 to display additional messages 314a, 315a, 314b, and 315b after outputting the first agent message 313a. According to an embodiment, at least one additional message may be implemented in the form of a widget for one of a first format or a second format. For example, referring to FIG. 3C, additional messages 314a and 315a of the first format may be configured to include a name, reviews, location, price, and rating, and additional messages 314b and 315b of the second format may be configured to include a name, thumbnail image, price, and rating. According to an embodiment, the server 101 may cause a detailed page regarding the selected additional message to be displayed in response to the selection of at least one additional message by the user device 100. For example, referring to FIGS. 3C and 3D, in response to the selection of the additional message 314a or 314b by the user device 100, the server 101 may cause a detailed page including a plurality of information items regarding the additional message 314a or 314b to be displayed through the context display window screen 330. That is, the server 101 can identify a request of the user device 100 occurring through the chat window screen 310 (e.g., a user interaction with the additional message 314a or 314b) and perform an operation corresponding to the request (e.g., displaying a detailed information screen) through the context display window screen 330.

In operation 207, according to various embodiments, a server 101 (e.g., a processor 121 of FIG. 1) may, in response to identifying third context information related to a travel place condition from a second user message received from a user device 100, output a second agent message including at least a portion of first context information, the third context information, and second search result information corresponding to a specific query to a chat window screen 310, while causing the user device 100 to display at least one second object for fourth context information corresponding to the second search result information on a context display window screen 330.

According to an embodiment, the server 101 may identify the third context information related to the travel place condition from the second user message. According to an embodiment, the third context information related to the travel place condition may include at least one of a review score condition, a price range condition, a location condition, a place characteristic condition, an age range condition, a gender condition, a number of people condition, an accommodation type (e.g., hotel/motel, etc.) condition, an accommodation grade (e.g., hotel star rating) condition, or an amenity (e.g., breakfast/Wi-Fi availability, etc.) condition. The aforementioned examples are merely illustrative and are not limited to these instances, and the types or items thereof may be freely changed by the settings of a user of the user device 100 or an administrator of the server 101. For example, referring to FIG. 4A, the server 101 may identify a price condition (e.g., 150,000 KRW or less per night) as the third context information from the second user message 312b (e.g., “Nice, but it's a bit expensive. Are there any places for 150,000 KRW or less per night?”).

According to an embodiment, in response to identifying the third context information through an intelligent agent, the server 101 may cause the user device 100 to display the third context information on the travel itinerary display window screen.

According to various embodiments, in response to identifying the third context information, the server 101 (e.g., the processor 121 of FIG. 1) may output the second agent message including at least a portion of the first context information, the third context information, and the second search result information corresponding to the specific query to the chat window screen 310.

According to an embodiment, the server 101 may identify the second search result information determined by the intelligent agent based on at least a portion of the first context information, the third context information, and the specific query. For example, referring to FIG. 4A, the intelligent agent may identify the second search result information (e.g., third accommodation information, fourth accommodation information) by using travel region information (e.g., Gangneung) of the first context information, the price condition (e.g., 150,000 KRW or less) of the third context information, and a specific query (e.g., accommodation information) regarding a current conversation session.

According to an embodiment, the server 101 may generate the second agent message including the second search result information as an answer message obtained by inputting the second user message into a large language model through the intelligent agent. For example, referring to FIG. 4A, the server 101 may cause the user device 100 to display the second agent message 313b including the second search result information on the chat window screen 310.

According to an embodiment, while outputting the second agent message to the chat window screen 310, the server 101 may cause the user device 100 to display at least one second object for the fourth context information corresponding to the second search result information on the context display window screen 330. The description of the fourth context information may apply the description of the second context information in operation 205 mutatis mutandis. For example, referring to FIG. 4A, while causing the user device 100 to display the second agent message 313b through the intelligent agent, the server 101 may cause location indicators 431 and 432 for the fourth context information (e.g., location information of the third accommodation and location information of the fourth accommodation) to be displayed within a map app screen currently running on the context display window screen 330.

According to various embodiments, in response to identifying a specific query from a third user message received from the user device 100, the server 101 may identify at least one piece of context information and third search result information corresponding to another specific query. For example, referring to FIG. 4B, in response to identifying a specific query (e.g., activity information) from the third user message 312c (e.g., “Are there any activities I can do with children?”), the server 101 may identify the third search result information (e.g., first activity information and second activity information) determined by the intelligent agent based on the travel region information (e.g., Gangneung) of the first context information, age condition (e.g., child) of the third context information, and the specific query (e.g., activity information).

According to an embodiment, the server 101 may generate a third agent message including the third search result information as an answer message obtained by inputting the third user message into the large language model through the intelligent agent. For example, referring to FIG. 4B, the server 101 may cause the user device 100 to display the third agent message 313c including the third search result information on the chat window screen 310.

According to an embodiment, while outputting the third agent message to the chat window screen 310, the server 101 may cause the user device 100 to display at least one object for fifth context information corresponding to the third search result information on the context display window screen 330. The description of the fifth context information may apply the description of the second context information in operation 205 mutatis mutandis. For example, referring to FIG. 4B, while causing the user device 100 to display the third agent message 313c through the intelligent agent, the server 101 may cause location indicators 441 and 442 for the fifth context information (e.g., location information of the first activity and location information of the second activity) to be displayed within the map app screen currently running on the context display window screen 330.

According to an embodiment, in response to identifying new search result information, the server 101 may switch from a first screen including an object for context information corresponding to previous search result information to a second screen including an object for context information corresponding to the new search result information. That is, every time the server 101 identifies new search result information, it may cause the user device 100 to immediately switch the first screen (e.g., the context display window screen 330 of FIG. 4A) to the second screen (e.g., the context display window screen 330 of FIG. 4B).

According to an embodiment, the server 101 may cause the user device 100 to display at least one additional message supporting the agent message through the intelligent agent. For example, referring to FIGS. 4B and 4C, the server 101 may cause the user device 100 to display additional messages 414a, 415a, 414b, and 415b after outputting the third agent message 313c. According to an embodiment, the at least one additional message may be implemented in a widget form for one of a first format or a second format, similar to the additional messages 314a, 315a, 314b, and 315b. According to an embodiment, in response to the selection of the at least one additional message by the user device 100, the server 101 may cause a detailed page regarding the selected additional message to be displayed. For example, referring to FIGS. 4C and 4D, in response to the selection of the additional message 415b by the user device 100, the server 101 may cause a detailed page including a plurality of information items regarding the additional message 415a or 415b to be displayed through the context display window screen 330. That is, the server 101 may identify a request of the user device 100 occurring through the chat window screen 310 (e.g., a user interaction with the additional message 415a or 415b) and perform an operation corresponding to the request (e.g., displaying a detailed information screen) through the context display window screen 330.

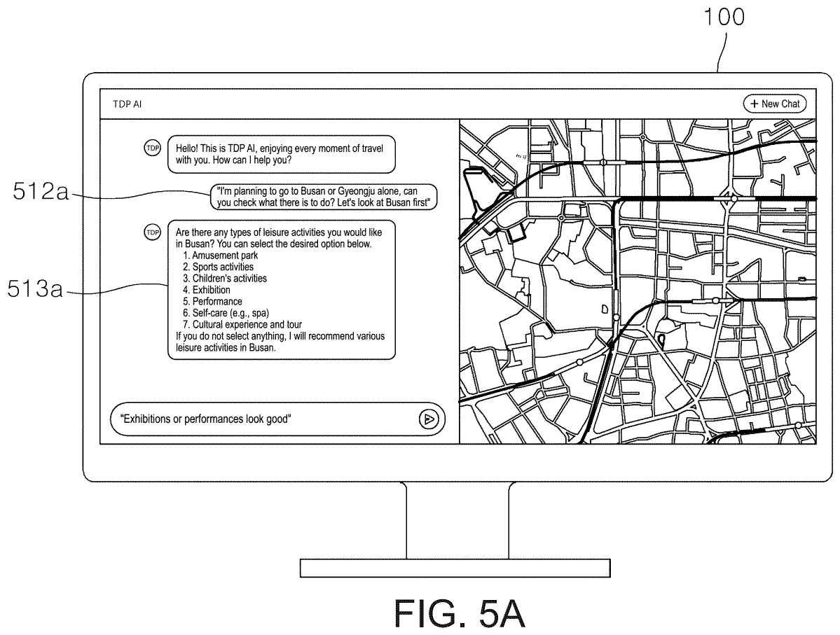

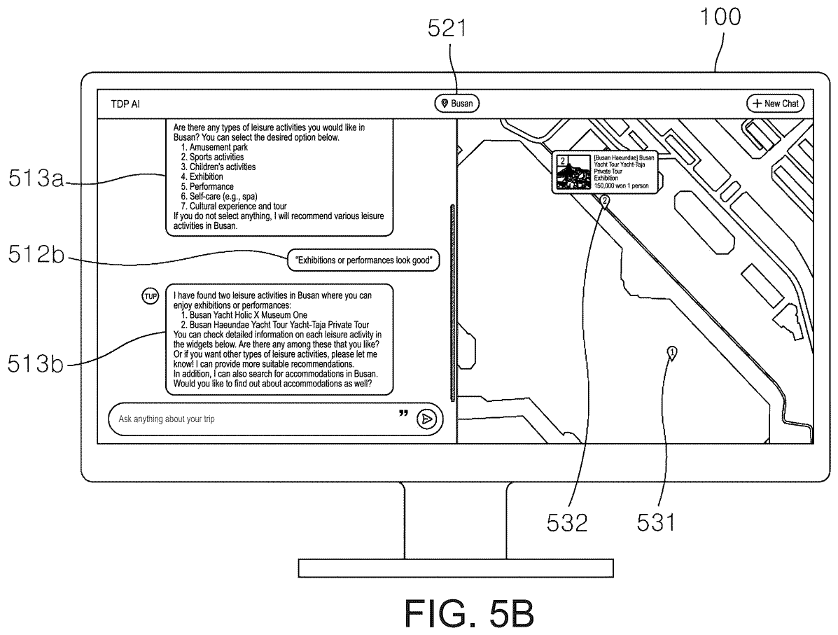

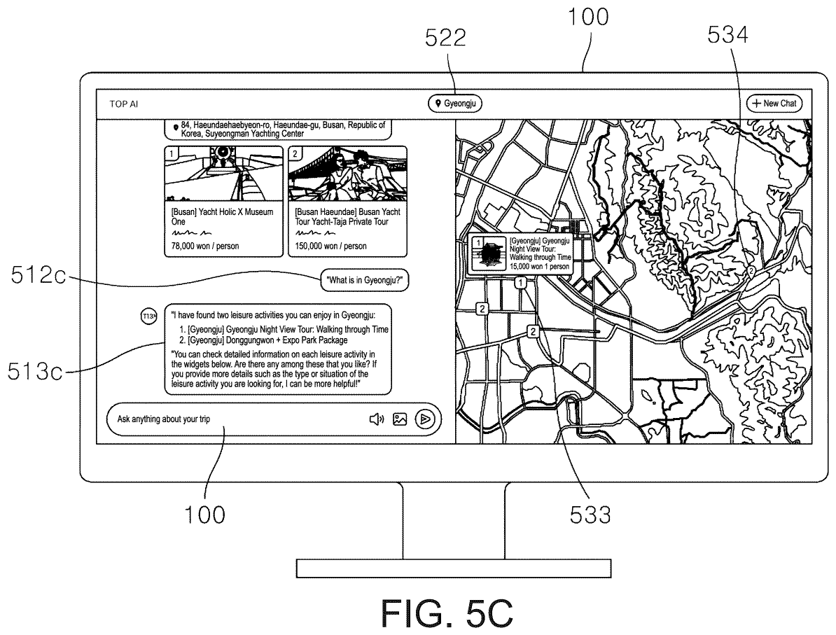

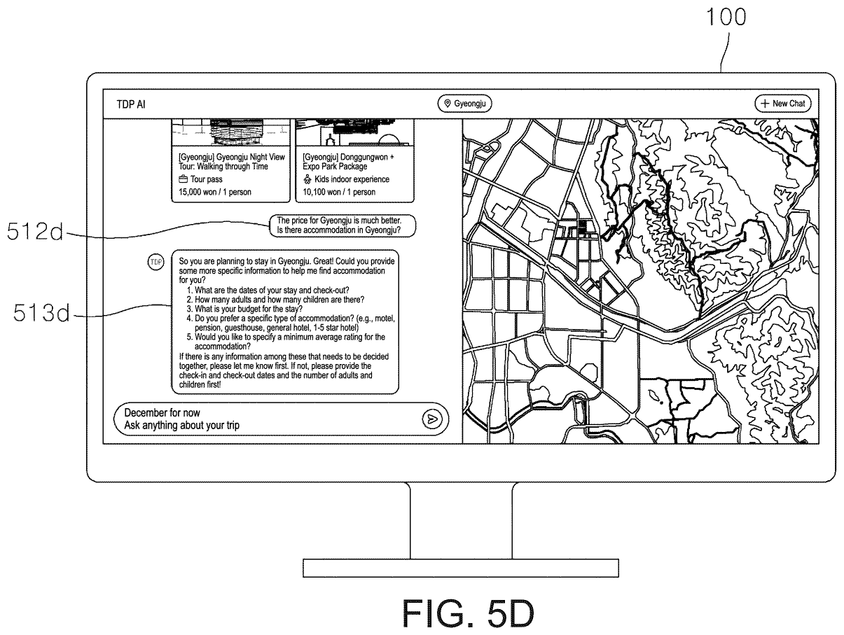

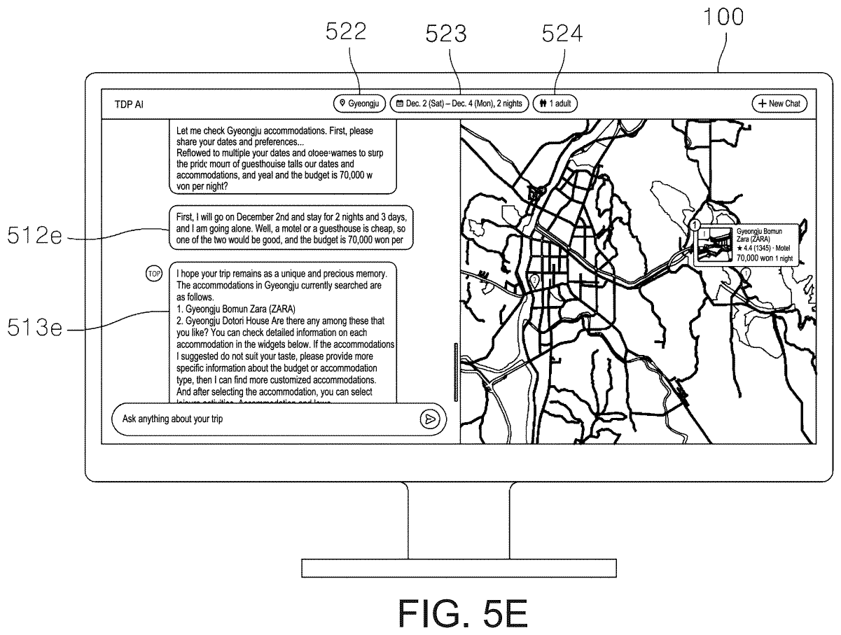

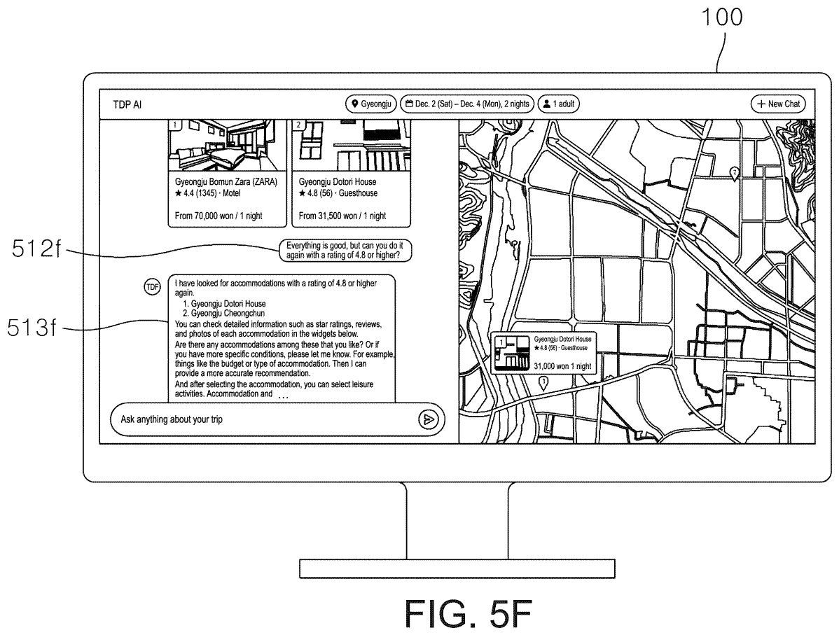

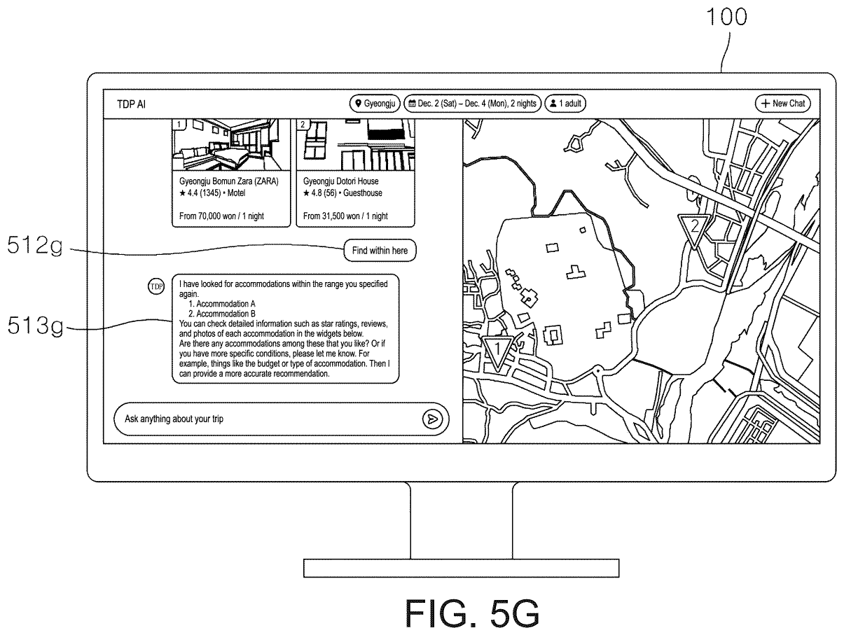

FIGS. 5A to 5G are diagrams illustrating an embodiment in which a server (e.g., the server 101 of FIG. 1) causes an object for context information to be changed and displayed according to a change in the content of a user message during a conversation with a user device (e.g., the user device 100 of FIG. 1) through an intelligent agent according to various embodiments.

According to various embodiments, a server 101 (e.g., a processor 121 of FIG. 1) may cause a user device 100 to display at least one chat message transmitted to and received from an intelligent agent based on a large language model (LLM) on a chat window screen. For example, referring to FIG. 5A, the server 101 may receive a first user message 512a (e.g., “I'm planning to go to Busan or Gyeongju alone, can you check what there is to do? Let's look at Busan first”) from the user device 100 and cause the user device 100 to display the first user message 512a on a chat window screen 310.

According to an embodiment, in response to identifying first context information related to a travel itinerary from the first user message received from the user device 100, the server 101 may cause the user device 100 to display the first context information on a travel itinerary display window screen 320. For example, the server 101 may identify travel region information 521 (e.g., Busan) as the first context information from the first user message 512a and cause the user device 100 to display the first context information on the travel itinerary display window screen 320.

According to an embodiment, the server 101 may generate a first agent message including first search result information as an answer message obtained by inputting the first user message into the large language model through the intelligent agent. For example, referring to FIG. 5A, the server 101 may cause the user device 100 to display the first agent message 513a including the first search result information on the chat window screen 310.

According to various embodiments, the server 101 may identify at least one piece of context information and second search result information corresponding to a specific query in response to identifying the specific query from a second user message received from the user device 100. For example, referring to FIG. 5B, the server 101 may, in response to identifying a specific query (e.g., tour information) from the second user message 512b (e.g., “Exhibitions or performances look good”), identify the second search result information (e.g., first tour information and second tour information) determined by the intelligent agent based on the travel region information (e.g., Busan) of the first context information and the specific query (e.g., tour information).

According to an embodiment, the server 101 may generate a second agent message including the second search result information as an answer message obtained by inputting the second user message into the large language model through the intelligent agent. For example, referring to FIG. 5B, the server 101 may cause the user device 100 to display the second agent message 513b including the second search result information on the chat window screen 310.

According to an embodiment, while outputting the second agent message to the chat window screen 310, the server 101 may cause the user device 100 to display at least one object for context information corresponding to the second search result information on a context display window screen 330. For example, referring to FIG. 5B, the server 101 may cause the user device 100 to display the second agent message 513b through the intelligent agent on the chat window screen 310 while causing location indicators 531, 532 for context information (e.g., location information of the first tour and location information of the second tour) corresponding to the second search result information to be displayed within a map app screen currently running on the context display window screen 330.

According to an embodiment, in response to identifying first context information and a specific query together, a server 101 may cause a user device 100 to display the first context information on a travel itinerary display window screen 320. For example, referring to FIGS. 5A and 5B, the server 101 may identify the first context information (e.g., Busan) from a first user message 512a and identify the specific query (e.g., tour information) from a second user message 512b, and then cause the user device 100 to display the first context information 521 (e.g., Busan) on the travel itinerary display window screen 320. In the aforementioned example, the operation of identifying the specific query may include an operation of identifying from an agent message (e.g., accommodation information in message 313) by an intelligent agent, in addition to identifying from the user message.

According to various embodiments, the server 101 (e.g., a processor 121 of FIG. 1) may identify third search result information corresponding to another piece of first context information and the latest specific query in response to identifying the other first context information related to a travel itinerary from a third user message received from the user device 100. For example, referring to FIG. 5C, in response to identifying context information related to a travel itinerary (e.g., Gyeongju) from a third user message 512c (e.g., “What is in Gyeongju?”), the server 101 may identify the third search result information (e.g., third tour information and fourth tour information) determined by the intelligent agent based on the other first context information (e.g., Gyeongju) and the most recently identified specific query (e.g., tour information).

According to an embodiment, the server 101 may generate a third agent message including the third search result information as a response message obtained by inputting the third user message into a large language model through the intelligent agent. For example, referring to FIG. 5C, the server 101 may cause the user device 100 to display the third agent message 513c including the third search result information on a chat window screen 310.

According to an embodiment, while outputting the third agent message to the chat window screen 310, the server 101 may cause the user device 100 to display at least one object for context information corresponding to the third search result information on a context display window screen 330. For example, referring to FIG. 5C, while causing the user device 100 to display the third agent message 513c on the chat window screen 310 through the intelligent agent, the server 101 may cause location indicators 533 and 534 for context information (e.g., location information of the third tour and location information of the fourth tour) corresponding to the third search result information to be displayed within a map application screen currently running on the context display window screen 330.

According to various embodiments, in response to identifying another specific query from a fourth user message received from the user device 100, the server 101 may identify at least one piece of context information and fourth search result information corresponding to the other specific query. For example, referring to FIG. 5D, in response to identifying the other specific query (e.g., accommodation information) from a fourth user message 512d (e.g., “The price for Gyeongju is much better. Is there accommodation in Gyeongju?”), the server 101 may identify the fourth search result information (e.g., first accommodation information and second accommodation information) determined by the intelligent agent based on travel region information (e.g., Gyeongju) of context information related to a travel itinerary and the other specific query (e.g., accommodation information).

According to an embodiment, the server 101 may generate a fourth agent message including the fourth search result information as a response message obtained by inputting the fourth user message into the large language model through the intelligent agent. For example, referring to FIG. 5D, the server 101 may cause the user device 100 to display a fourth agent message 513d including the fourth search result information on the chat window screen 310.

According to various embodiments, in response to identifying a plurality of context information from a fifth user message received from the user device 100, the server 101 may identify the plurality of context information and fifth search result information corresponding to the specific query. For example, referring to FIG. 5E, the server 101 identifies travel date information (e.g., December 2 (Sat)-December 4 (Mon), 2 nights) and travel personnel information (e.g., 1 adult) as context information related to a travel itinerary from a fifth user message 512e (e.g., “First, I'll go on December 2nd and stay for 2 nights and 3 days, and I'm going alone. Well, a motel or a guesthouse is cheap, so one of the two would be good, and the budget is 70,000 won per night?”), and in response to identifying place characteristic conditions (e.g., motel or guesthouse) and a price condition (e.g., 70,000 won or less) as context information related to travel place conditions, the server 101 may identify fifth search result information (e.g., third accommodation information and fourth accommodation information) determined by the intelligent agent based on the context information and the specific query (e.g., accommodation information).

According to an embodiment, the server 101 may generate a fifth agent message including the fifth search result information as a response message obtained by inputting the fifth user message into the large language model through the intelligent agent. For example, referring to FIG. 5E, the server 101 may cause the user device 100 to display the fifth agent message 513e including the fifth search result information on the chat window screen 310.

According to an embodiment, in response to additionally identifying context information related to a travel itinerary from the fifth user message received from the user device 100, the server 101 may cause the user device 100 to additionally display the context information on the travel itinerary display window screen 320. For example, in response to identifying travel date information 523 and travel personnel information 524 as additional context information related to a travel itinerary from the fifth user message 512e, the server 101 may cause the user device 100 to additionally display the additional context information on the travel itinerary display window screen 320.

According to various embodiments, the server 101 (e.g., the processor 121) may identify sixth search result information corresponding to at least a portion of the context information related to the travel itinerary, context information related to travel place conditions, and the specific query in response to identifying the context information related to the travel place conditions from a sixth user message. For example, referring to FIG. 5F, in response to identifying a review score condition (e.g., 4.8 or higher) as the context information related to the travel place conditions from a sixth user message 512f (e.g., “Everything is good, but can you do it again with a rating of 4.8 or higher?”), the server 101 may identify the sixth search result information (e.g., fifth accommodation information and sixth accommodation information) determined by the intelligent agent based on the context information related to the travel itinerary, the context information related to the travel place conditions, and the specific query (e.g., accommodation information).

According to an embodiment, the server 101 may generate a sixth agent message including the sixth search result information as a response message obtained by inputting the sixth user message into the large language model through the intelligent agent. For example, referring to FIG. 5F, the server 101 may cause the user device 100 to display the sixth agent message 513f on the chat window screen 310.

According to various embodiments, after displaying an object for context information corresponding to specific search result information on the context display window screen 330, the server 101 (e.g., the processor 121) may, in response to identifying an additional search condition expression from a user message within the chat window screen 310, identify search result information corresponding to the condition information specified by the first context information, the third context information, the specific query, and the additional search condition expression. According to an embodiment, the condition information specified by the additional search condition expression may be condition information (e.g., a regional range, a price range, etc.) specified by the user device 100 through the context display window screen 330. For example, as in FIG. 5F, after displaying an object (e.g., a location of accommodation) for context information corresponding to specific search result information on the context display window screen 330, the server 101 may, in response to identifying an additional search condition expression (e.g., “within here”) from a user message 512g (e.g., “Find within here”) as in FIG. 5G, identify search result information corresponding to the first context information (e.g., travel region/date/personnel), the third context information (e.g., accommodation type/cost/review score conditions), the specific query (e.g., accommodation information), and the condition information specified by the additional search condition expression (e.g., within the regional range displayed on the context display window screen 330). In the aforementioned example, the user of the user device 100 may, to intuitively input desired condition information, input the user message including the additional search condition expression into the chat window screen 310 after changing the content displayed on the context display window screen 330 (e.g., moving the regional range displayed on the map application screen).

According to an embodiment, referring to FIG. 5G, the server 101 may generate an agent message 513g including search result information by inputting the user message 512g into the large language model through the intelligent agent, and cause the message to be displayed on the chat window screen 310.

According to an embodiment, referring to FIG. 5G, while causing the user device 100 to display the agent message 513g on the chat window screen 310 through the intelligent agent, the server 101 may cause location indicators for context information (e.g., location information of accommodation A and location information of accommodation B) corresponding to the search result information to be displayed within the map application screen currently running on the context display window screen 330.

According to an embodiment, as the server 101 scrolls through a history of user messages and agent messages within the chat window screen 310 by user input on the user device 100, the server 101 may display a screen including an object for context information corresponding to an agent message displayed on the chat window screen 310 on the context display window screen 330. For example, in a state where the agent message 513c of FIG. 5C is displayed on the chat window screen 310 of the user device 100 and the map application screen of FIG. 5C is displayed on the context display window screen 330, as the user device 100 displays the agent message 513b of FIG. 5B on the chat window screen 310 by user input (e.g., scrolling up), the server 101 may cause the user device 100 to switch from a first screen (e.g., the map application screen of FIG. 5C) to a second screen (e.g., the map application screen of FIG. 5B) displayed on the context display window screen 330. As another example, in a state where the agent message 513c of FIG. 5C is displayed on the chat window screen 310 and the map application screen of FIG. 5C is displayed on the context display window screen 330, as the user device 100 displays the agent message 513e of FIG. 5E on the chat window screen 310 by user input (e.g., scrolling down), the server 101 may cause the user device 100 to switch from the first screen (e.g., the map application screen of FIG. 5C) to a second screen (e.g., the map application screen of FIG. 5E) displayed on the context display window screen 330.

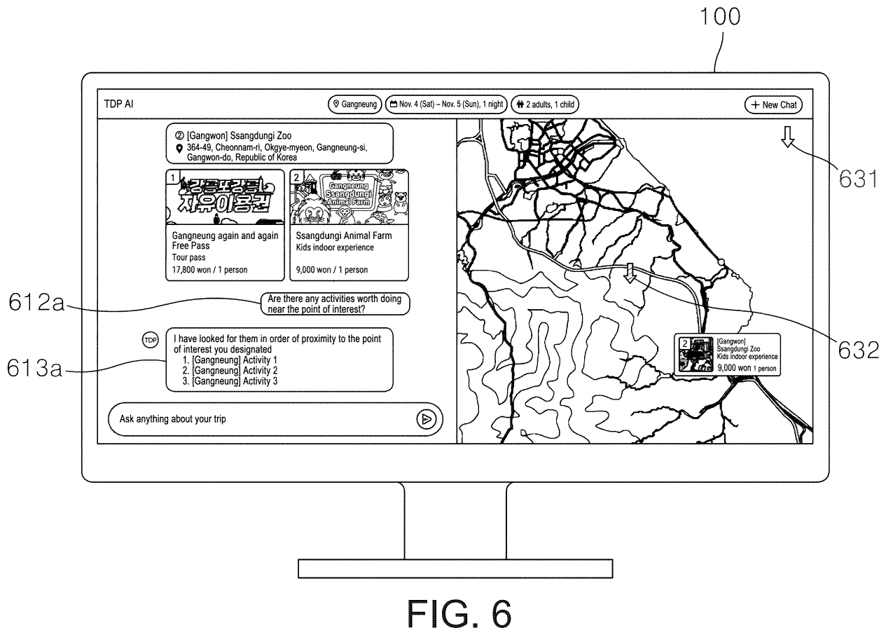

FIG. 6 is a diagram illustrating an embodiment in which a server generates a user message to be input to an intelligent agent based on user input confirmed through a context display window screen according to various embodiments.

According to various embodiments, the server 101 (e.g., the processor 121 of FIG. 1) may cause the user device (e.g., the user device 100 of FIG. 1) to display an indicator for specifying context information related to a travel location condition on the context display window screen 330.

According to an embodiment, referring to FIG. 6, a user may move a location designating indicator 631 displayed on the context display window screen in a display of the user device 100 and place it at a specific point 632 within a map application screen. The server 101 may generate a user message 612a (e.g., “Are there any activities worth doing near the point of interest?”) with information regarding the specific point and input the generated message into a large language model linked with the intelligent agent. According to an embodiment, the information regarding the specific point may include location information within a predetermined distance from the specific point, and the predetermined distance may be freely changed by an administrator of the server 101 or the user of the user device 100.

According to an embodiment, the server 101 may identify at least one piece of context information and search result information corresponding to a specific query in response to identifying context information related to a travel location condition from the user message. For example, referring to FIG. 6, after performing the operation of FIG. 4C, the server 101 may identify context information regarding the specific point 632 using the location designating indicator 631 and verify search result information (e.g., first activity information and second activity information) corresponding to the context information and the specific query (e.g., activities).

According to an embodiment, the server 101 may generate an agent message including the search result information as a response message obtained by inputting the user message into the large language model through the intelligent agent. For example, referring to FIG. 6, the server 101 may cause the user device 100 to display the agent message 613a including the search result information on a chat window screen 310.

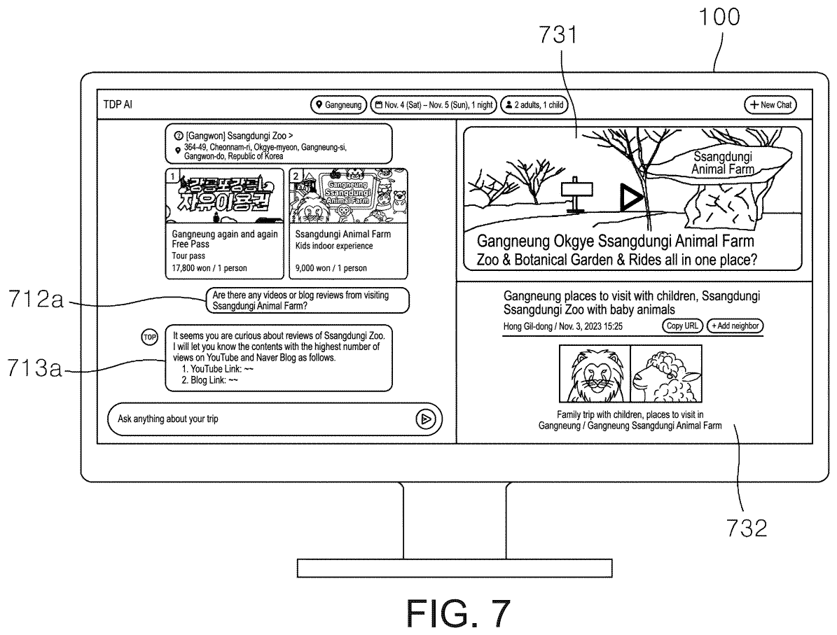

FIG. 7 is a diagram illustrating an embodiment in which a server (e.g., the server 101 of FIG. 1) provides a plurality of contents through a context display window screen divided into a plurality of areas according to various embodiments.

According to an embodiment, referring to FIG. 7, the server 101 may generate an agent message 713a including search result information corresponding to a specific query and context information, as a response message obtained by inputting a user message 712a into a large language model through an intelligent agent. The server 101 may cause a user device 100 to display the agent message 713a on a chat window screen 310.

According to an embodiment, the server 101 may divide a context display window screen 330 into a plurality of regions for executing a plurality of apps in response to identifying a plurality of pieces of app execution information from context information corresponding to search result information, and may execute an app corresponding to the search result information through each independent region. For example, referring to FIG. 7, after performing the operation of FIG. 4C, the server 101 may cause the agent message 713a for the user message 712a to be displayed on the chat window screen 310. In response to identifying a plurality of pieces of app execution information (e.g., a YouTube link, a web page link) from context information corresponding to search result information included in the agent message 713a, the server 101 may divide the context display window screen 330 into two regions. The server 101 may cause first content through a YouTube app (e.g., a video review of “Ssangdungi Animal Farm”) to be displayed in an upper region, and cause second content through a web browser (e.g., a blog review of “Ssangdungi Animal Farm”) to be displayed in a lower region.

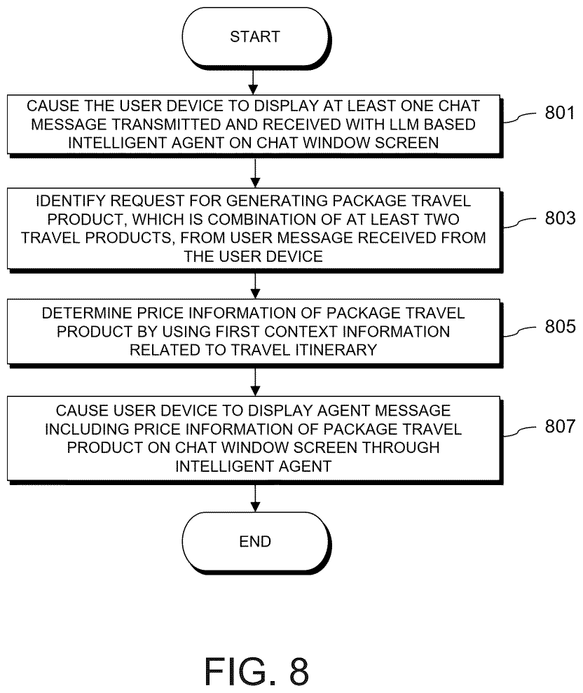

FIG. 8 is a flowchart illustrating an operation in which a server (e.g., the server 101 of FIG. 1) provides a package travel product according to various embodiments.

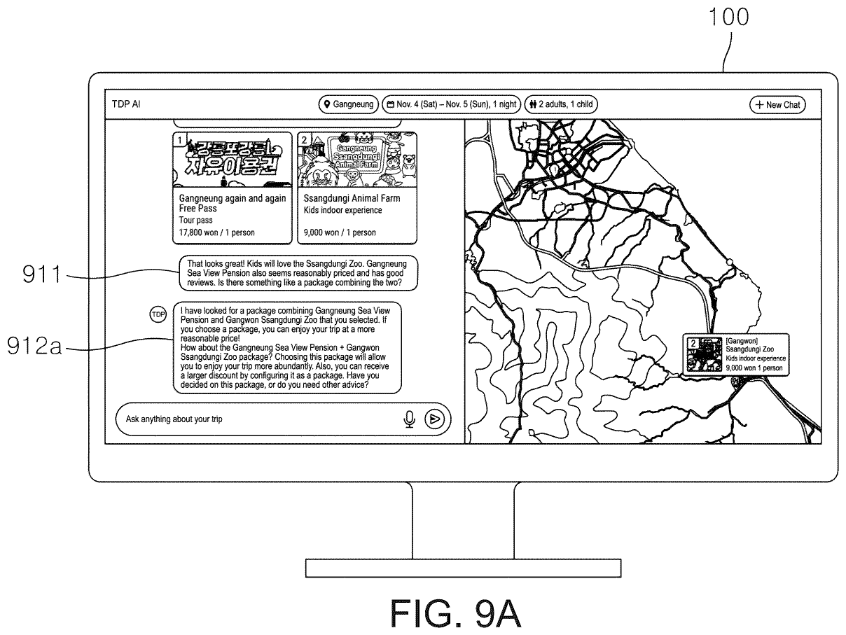

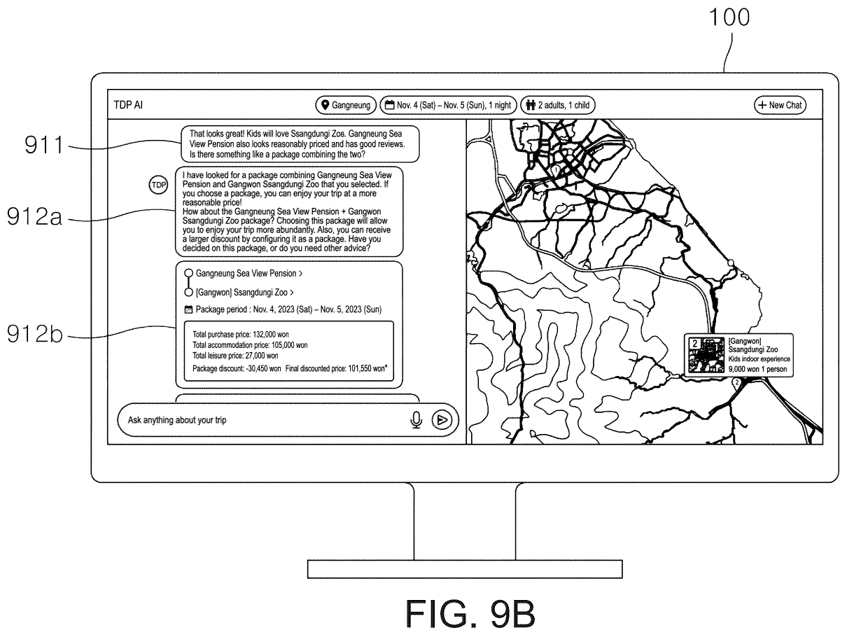

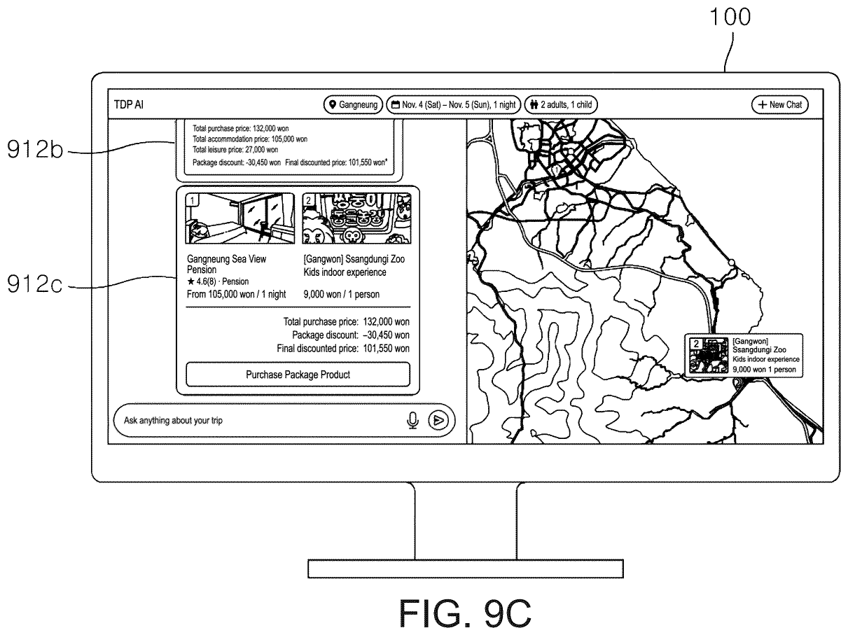

FIGS. 9A to 9C illustrate a first embodiment in which a server provides a package travel product according to various embodiments.

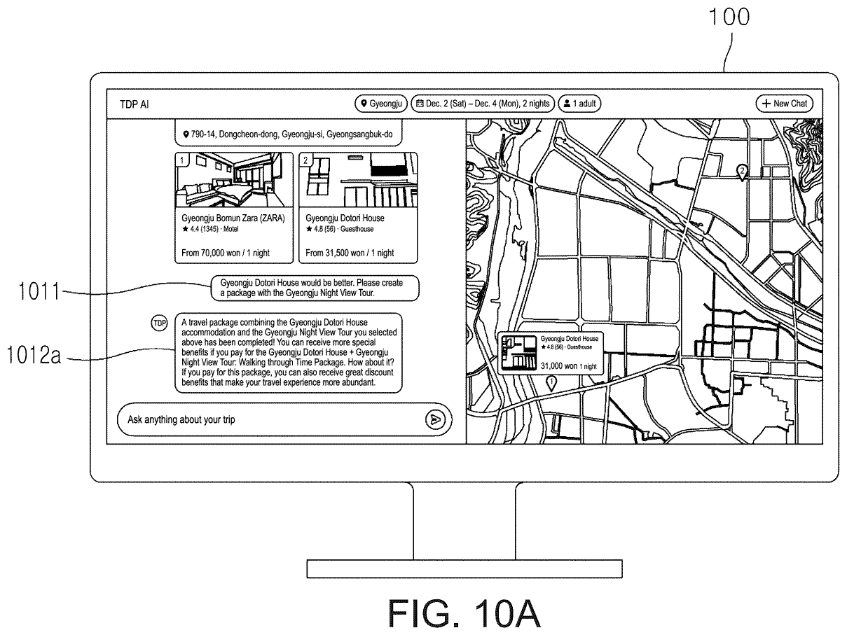

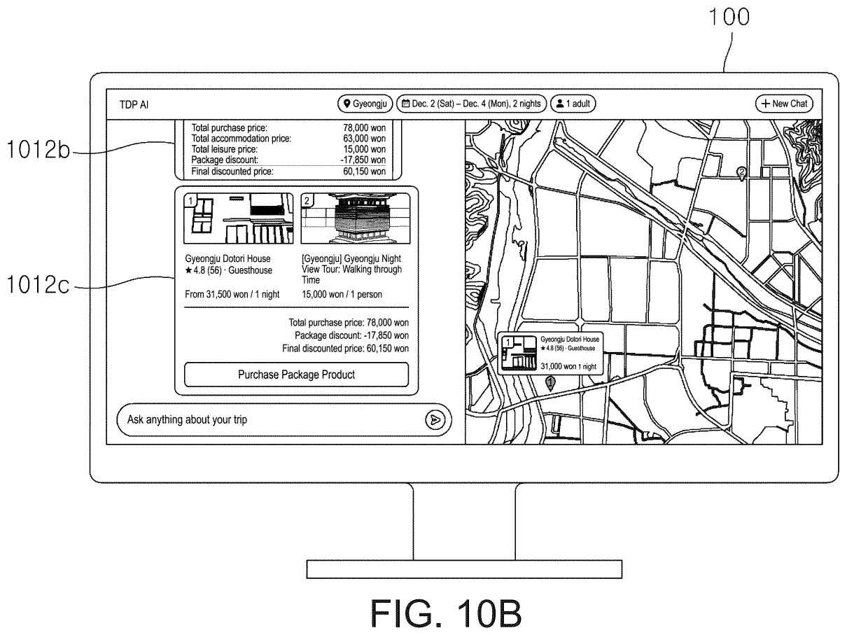

FIGS. 10A to 10B illustrate a second embodiment in which a server provides a package travel product according to various embodiments.

In operation 801, according to various embodiments, the server 101 (e.g., the processor 121 of FIG. 1) may cause a user device (e.g., the user device 100 of FIG. 1) to display at least one chat message transmitted to and received from a large language model based intelligent agent on a chat window screen. According to an embodiment, the server 101 may perform operation 801 using the method described in operation 201 of FIG. 2.

In operation 803, according to various embodiments, the server 101 (e.g., the processor 121 of FIG. 1) may identify a request for generating a package travel product, which is a combination of at least two travel products, from a user message received from the user device 100. According to an embodiment, the server 101 may identify the request for generating the package travel product as a specific query.

According to an embodiment, the server 101 may identify information on at least two travel products and the request for the package travel product combining the said at least two travel products from the user message. For example, referring to FIG. 9A, the server 101 may identify a name of a first travel product (e.g., Gangneung Sea View Pension) and a name of a second travel product (e.g., Ssangdungi Zoo) from a user message 911, and may identify the request for generating the package travel product combining the travel products as a specific query to input the same into the intelligent agent. As another example, referring to FIG. 10A, the server 101 may identify a name of a first travel product (e.g., Gyeongju Dotori House) and a name of a second travel product (e.g., Gyeongju Night View Tour) from a user message 1011, and may identify the request for generating the package travel product combining the travel products as a specific query to input the same into the intelligent agent.

According to an embodiment, the server 101 may check a previous chat message history transmitted and received between the user device 100 and the intelligent agent, and may identify information on at least two travel products to be combined into a package travel product from the previous chat message history.

According to various embodiments, even if the request for generating a package travel product is not obtained from the user device 100, the server 101 (e.g., the processor 121 of FIG. 1) may determine to automatically generate the package travel product under a specific condition.

According to an embodiment, the server 101 may input at least one chat message transmitted and received between the user device 100 and the intelligent agent into a transformer-based prediction model to determine at least two travel products to be recommended to the user device 100. For example, the server 101 may input a plurality of chat messages (e.g., chat messages from an agent message 313 of FIG. 3A to an agent message 415b of FIG. 4C) transmitted and received between the user device 100 and the intelligent agent for a first time period or by a first number from a time point when a specific query or third context information is identified into the transformer-based prediction model, to determine a name of a first travel product (e.g., Gangneung Sea View Pension) and a name of a second travel product (e.g., Ssangdungi Zoo) to be recommended to the user device 100. As another example, the server 101 may input a plurality of chat messages (e.g., chat messages from a user message 312b of FIG. 4A to an agent message 415b of FIG. 4C) transmitted and received between the user device 100 and the intelligent agent for a second time period or by a second number from a time point when a specific query or third context information is identified into the transformer-based prediction model, to determine a name of a first travel product (e.g., Gangneung Sea View Pension) and a name of a second travel product (e.g., Ssangdungi Zoo) to be recommended to the user device 100.

According to an embodiment, the transformer-based prediction model for recommending at least two travel products may be trained based on a correlation between (i) a plurality of chat messages transmitted and received between a plurality of user devices and the intelligent agent for a first time period or by a first number from a time point when a specific query or third context information is identified and (ii) a package travel product whose purchase is determined by the plurality of user devices. Meanwhile, the transformer-based prediction model may be implemented within a large language model or as a separate model.

In operation 805, according to various embodiments, the server 101 (e.g., the processor 121 of FIG. 1) may determine price information of the package travel product using first context information related to a travel itinerary.

According to various embodiments, the server 101 (e.g., the processor 121 of FIG. 1) may determine the price information of the package travel product by using travel date information and travel personnel information as the first context information.

According to an embodiment, the server 101 may identify a discount weight corresponding to a type of the at least two travel products. According to an embodiment, as shown in [Table 1] below, the server 101 may store a table mapping a discount weight for each type of travel product in a memory (e.g., the memory 131 of FIG. 1), and may identify a discount weight corresponding to each type of travel product from the table. For example, the type of travel product may include transportation information, accommodation information, tourist spot information, restaurant information, tour information, ticket information, an activity package, a rental car service, travel insurance, a local SIM card or portable WiFi, a gift certificate or voucher, a transportation pass, a special event package, a personalized guided tour, an airport transfer service, and an experience product such as cooking or trying on Hanbok, and the aforementioned examples are merely illustrative and not limited thereto, and an administrator of the server 101 may designate discount weights for various types.

TABLE 1

| Travel Product | Discount Weight |
|---|---|
| Accommodation | A |
| Tourist Attraction | B |
| Restaurant | C |
| . . . | . . . |
| Ticket | N |

According to an embodiment, types of travel products may be divided into a plurality of classification systems (e.g., major classification/middle classification/minor classification, etc.) as shown in [Table 2] below, and an administrator of the server 101 may designate a discount weight for each specific classification system.

TABLE 2

| | | | Discount |
|---|---|---|---|
| Major Category | Middle Category | Minor Category | Weight |
| Accommodation | Hotel | 1-star to 2-star | A |
| | | 3-star or more | B |
| | Motel | — | C |
| | Guesthouse | — | D |
| Restaurant | Japanese food | — | E |
| | Korean food | Stew restaurant | |
| | | Grill restaurant | |

According to an embodiment, the server 101 may designate different discount weights according to travel date information and travel personnel information for each type of travel product. According to an embodiment, the server 101 may calculate cost information by applying travel date information and travel personnel information to price information of at least two travel products. For example, referring to FIG. 9B, the server 101 calculates a first cost information (e.g., 105,000 won) by applying travel date information (e.g., 1 night) confirmed from the travel itinerary display window screen 320 to price information (e.g., 105,000 won) of a first travel product (e.g., Gangneung Sea View Pension), and calculates a second cost information (e.g., 27,000 won) by applying travel personnel information (e.g., 3 people) confirmed from the travel itinerary display window screen 320 to price information (e.g., 9,000 won) of a second travel product (e.g., Ssangdungi Zoo). As another example, referring to FIG. 10B, the server 101 calculates a first cost information (e.g., 105,000 won) by applying travel date information (e.g., 1 night) confirmed from the travel itinerary display window screen 320 to price information (e.g., 105,000 won) of a first travel product (e.g., Gyeongju Dotori House), and calculates a second cost information (e.g., 27,000 won) by applying travel personnel information (e.g., 3 people) confirmed from the travel itinerary display window screen 320 to price information (e.g., 9,000 won) of a second travel product (e.g., Ssangdungi Zoo).

According to an embodiment, the server 101 may calculate discount price information by applying discount weights by type to price information of at least two travel products. For example, referring to FIG. 9B, the server 101 may calculate a package discount price information (e.g., 30,450 won) by applying discount weights to a first travel product and a second travel product. As another example, referring to FIG. 10B, the server 101 may calculate a package discount price information (e.g., 17,850 won) by applying discount weights to a first travel product and a second travel product.

According to an embodiment, the server 101 may calculate a price information of a package travel product by summing the cost information and the discount price information. For example, referring to FIG. 9B, the server 101 may calculate a price information (e.g., 101,550 won) of a package travel product by summing the cost information and the discount price information of a first travel product and a second travel product. As another example, referring to FIG. 10B, the server 101 may calculate a price information (e.g., 60,150 won) of a package travel product by summing the cost information and the discount price information of a first travel product and a second travel product.

According to an embodiment, after identifying a request to create a package travel product, if travel date information or travel personnel information does not exist in the first context information, the server 101 may output an agent message requesting the corresponding information to the dialog window screen 310 through the intelligent agent. For example, after identifying a request to create a package travel product, if travel date information or travel personnel information cannot be confirmed from the travel itinerary display window screen 320, the server 101 may output an agent message requesting the unconfirmed information to the user device 100 through the intelligent agent.

In operation 807, according to various embodiments, the server 101 (e.g., the processor 121 of FIG. 1) may cause the user device 100 to display an agent message including the price information of the package travel product on the dialog window screen 310 through the intelligent agent.

According to an embodiment, the agent message including the price information of the package travel product may include a first sub-agent message representing a response-type message to a user message, a second sub-agent message representing detailed discount details, and a third sub-agent message configured to realize a function of purchasing the package travel product. For example, referring to FIGS. 9B and 9C, the agent message may include a first sub-agent message 912a, a second sub-agent message 912b, and a third sub-agent message 912c, and as shown in FIGS. 9B and 9C, the server 101 may cause the user device 100 to display the first sub-agent message to the third sub-agent message in order on the dialog window screen 310. As another example, referring to FIGS. 10A and 10B, the agent message may include a first sub-agent message 1012a, a second sub-agent message 1012b, and a third sub-agent message 1012c. According to an embodiment, the second sub-agent message may include names of at least two travel products, a package period, each cost information (detailed amount) and total cost information (total amount) of the at least two travel products, discount price information of the package travel product, and final price information (i.e., price information of the package travel product) obtained by subtracting the discount price information from the total cost information. According to an embodiment, the third sub-agent message may include thumbnails of at least two travel products, review rating information, each cost information, total cost information, discount price information of the package travel product, final price information obtained by subtracting the discount price information from the total cost information, and an object (e.g., “Purchase Package Product”) configured to execute a payment screen for purchasing the package travel product.

According to an embodiment, while outputting the agent message including the price information of the package travel product on the dialog window screen 310, the server 101 may cause the user device 100 to highlight and display a movement path between package travel products within a map application screen on the context display window screen 330. According to an embodiment, in response to a user of the user device 100 selecting a specific object of the agent message (e.g., a thumbnail of a travel product, a “Purchase Package Product” button, etc.) on the dialog window screen 310, the server 101 may cause an execution screen corresponding to the specific object (e.g., a detailed information page of a travel product, a package product payment page, etc.) to be displayed on the context display window screen 330.

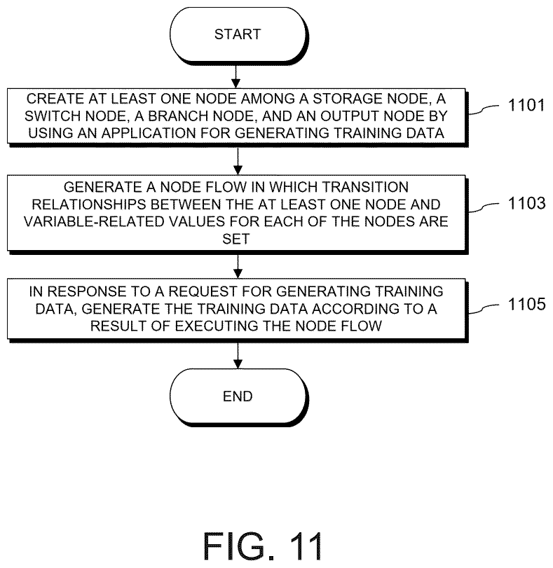

FIG. 11 is a flowchart illustrating an operation in which an electronic device (e.g., the user device 100 of FIG. 1) generates training data to be used for training a large language model according to various embodiments.

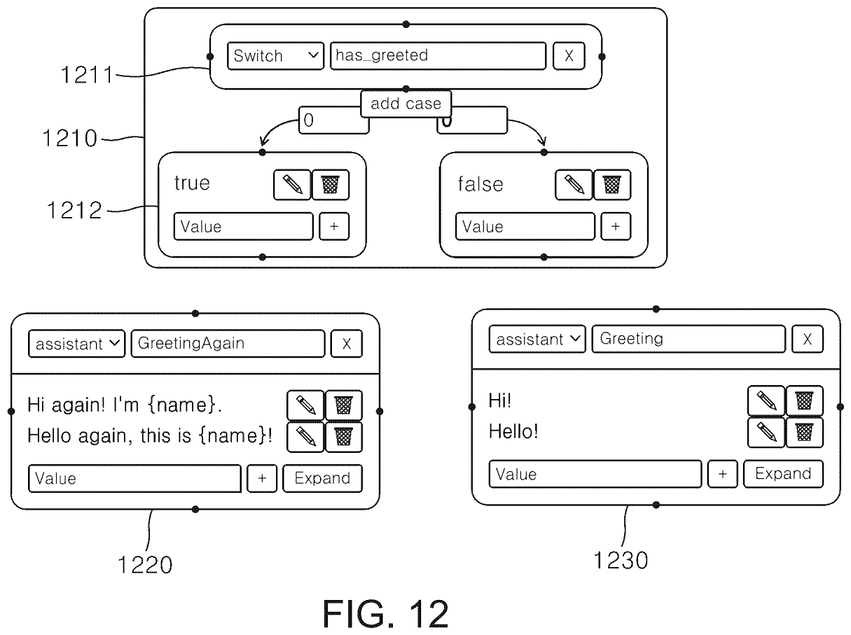

FIG. 12 is a diagram illustrating GUIs for each type of node used for generating training data according to various embodiments.

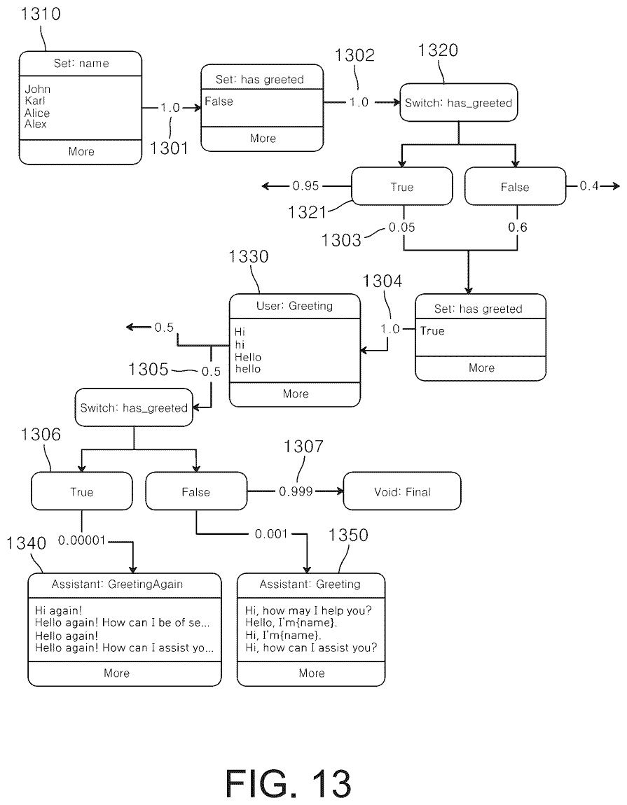

FIG. 13 is a diagram illustrating a node flow object in which a node flow is implemented in a GUI form according to various embodiments.

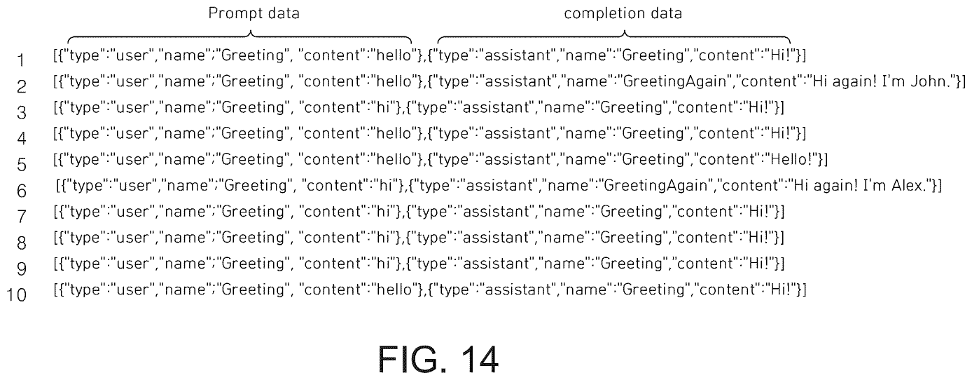

FIG. 14 is a diagram illustrating a training data set according to various embodiments.

According to various embodiments, a server 101 may store and manage a large language model (LLM), and may transmit source code to a user device 100 to enable the display of each execution screen of a dedicated application or a website for transmitting and receiving messages with the user device 100 through an intelligent agent based on the large language model. The user device 100 may receive the source code and display the execution screen requested by a user of the user device 100 through the dedicated application or a web browser.

In operation 1101, according to various embodiments, the electronic device 100 (e.g., the processor 120 of FIG. 1) may create at least one node among a storage node, a switch node, and an output node by using an application for generating training data to be used for training a large language model (LLM).

According to an embodiment, the large language model, as a type of generative AI, may include, for example, a transformer-based neural network model, and may be used for (1) a natural language understanding (NLU) field for understanding the meaning of sentences and performing tasks such as keyword extraction, sentiment analysis, and information retrieval, (2) a natural language generation (NLG) field for generating natural language in various forms such as sentences, paragraphs, summaries, and translations, (3) a query-answering field for generating answers to given questions, (4) a machine translation field for performing translation tasks between multiple languages, and (5) a text summarization field for increasing the value of information by concisely summarizing long texts. The large language model may include various language models that can be easily implemented by those skilled in the art in addition to the aforementioned examples.

According to an embodiment, the at least one node may be created in a program code form or in a graphic user interface (GUI) form through the application. According to an embodiment, the application may be an application providing an integrated development environment (IDE) that allows programming in various languages (e.g., Visual Studio).

According to an embodiment, the electronic device 100 may implement and display an object corresponding to a node used for generating training data in a GUI form on the application through a display (e.g., the display 140 of FIG. 1).

According to an embodiment, a storage node used for generating training data may be a component for storing at least one candidate storage variable value for a storage variable. Each of the at least one candidate storage variable values may be selected according to a preset probability value, and each probability value may be set to be the same as or different from each other by the user.

According to an embodiment, a switch node used for generating training data may be a component for setting a condition variable representing a branchable condition. According to an embodiment, referring to FIG. 12, a switch node object 1211 in which the switch node is implemented in a GUI form may include (i) a node selection object capable of selecting a type of node (e.g., Switch), (ii) a condition variable value field representing a condition variable (e.g., has_greeted), and (iii) a button for adding a candidate state value of a branch node (e.g., add case).

According to an embodiment, a branch node used for generating training data may be a component for setting a branchable candidate state value according to the current state of the condition variable of the switch node. According to an embodiment, referring to FIG. 12, a branch node object 1212 in which the branch node is implemented in a GUI form may include (i) a candidate state value (e.g., true), (ii) an object for modifying/removing the candidate state value, and (iii) a field for adding another candidate state value, and the branch node object 1212 may be implemented as one set 1210 with the switch node object 1211. The electronic device 100 may transition to a branch node having a value matching the current condition variable of the switch node. For example, if the switch node is set to a condition variable (e.g., apple_count), a first branch node connected to the switch node is set to a first candidate state value (e.g., 0, 1, 2), and a second branch node connected to the switch node is set to a second candidate state value (e.g., 3), the electronic device 100 may transition to the first branch node when the value of apple_count is the first candidate state value, and transition to the second branch node when the value is the second candidate state value, and may stop execution and generate an error when the value is any other value.

According to an embodiment, an output node used for generating training data may be a component for outputting at least one candidate output variable value for an output variable. Each of the at least one candidate output variable value may be selected according to a preset probability value, and each probability value may be set to be the same as or different from each other by the user. According to an embodiment, the output node may be set to output a type, an output variable (name), and content (i.e., a value selected among the candidate output variable values) of the output node. According to an embodiment, referring to FIG. 12, output node objects 1220 and 1230 in which the output node is implemented in a GUI form may include (i) an object capable of selecting a type of the output node (e.g., assistant), (ii) an output variable value field representing an output variable (e.g., GreetingAgain, Greeting), (iii) candidate output variable values (e.g., “Hi again! I'm {name}.”/“Hello again, this is {name}!”, “Hi!”/“Hello!”), (iv) an object for modifying/removing the candidate output variable values, and (v) a field for adding another candidate output variable value. According to an embodiment, the type of the output node may be either prompt data (e.g., user) corresponding to a virtual user message or completion data (e.g., assistant) corresponding to a virtual agent message. According to an embodiment, the type of the output node may be set to various types other than prompt data or completion data by the user of the electronic device 100.

According to various embodiments, training data generated according to the present disclosure may include data to be used for training a conversational LLM, data to be used for training a translation LLM, and data to be used for training a summarization LLM, and is not limited to the aforementioned examples and may include data to be used for training LLMs for various purposes. According to an embodiment, the training data may have a pair of properties such as prompt data and completion data for each data entry, or may have a single property (e.g., text) or three or more properties (e.g., question/correct answer/wrong answer, etc.).

When each node for generating training data and a node flow including the same are implemented in a GUI form, the nodes' transition relationships, transition probabilities, and each set value are intuitively recognized, thereby providing convenience for easily generating training data.

According to an embodiment, the at least one node used for generating training data may further include a void node that does not perform any operation, a start node, and an end node, and the start node and the end node may be expressed as void nodes or as nodes independent of the void node, which may be variously changed by the user's settings. According to an embodiment, the end node may include an object (preview function) capable of displaying a result of generating training data according to a node flow from the start node to the end node. According to an embodiment, the types of the at least one node described above are merely examples, and may include various types of nodes for generating training data in addition to the storage node, switch node, output node, and void node by the settings of the user of the electronic device 100 or the administrator of the server 101.

According to an embodiment, the electronic device 100 may create at least one node according to user input. For example, the electronic device 100 may receive a user input for creating a specific node (e.g., an output node) and create the specific node according to the user input.

In operation 1103, according to various embodiments, an electronic device 100 (e.g., a processor 120 of FIG. 1) may generate a node flow in which transition relationships between at least one node and variable-related values for each of the nodes are set. According to an embodiment, the node flow may define an execution order of a series of nodes for generating training data. Specifically, the node flow may represent transition relationships and transition probabilities between nodes from a start node (e.g., a first node) to an end node (e.g., a last node), and variable-related values within each node. According to an embodiment, the electronic device 100 may implement and display an object corresponding to the node flow in a GUI form on an application through a display 140. For example, FIG. 13 illustrates a draft for implementing the node flow in a GUI form as part of a node flow for generating training data for a conversational LLM.

According to various embodiments, the electronic device 100 (e.g., the processor 120 of FIG. 1) may set transition relationships between the at least one node.

According to an embodiment, the electronic device 100 may generate the node flow capable of generating training data by setting a transition relationship pointing from one node (e.g., a source node) to another node (e.g., a destination node) and a probability value for the transition relationship. The source node and the destination node merely denote relative concepts between two nodes and do not imply fixed roles; each node except for the start node and the end node may serve as a destination node while simultaneously becoming a new source node. According to an embodiment, types of the source node and the destination node may be the same or different.

According to an embodiment, referring to FIG. 13, the electronic device 100 may set a transition relationship 1301 from a storage node (e.g., Set: name) to a storage node (e.g., Set: has_greeted) and a probability value (e.g., 1) for the transition relationship 1301.

Referring to FIG. 13, the electronic device 100 may set a transition relationship 1302 from the storage node (e.g., Set: has_greeted) to a switch node (e.g., Switch: has_greeted) and a probability value (e.g., 1) for the transition relationship 1302.

Referring to FIG. 13, the electronic device 100 may set a transition relationship 1303 from a branch node (e.g., True) to the storage node (e.g., Set: has_greeted) and a probability value (e.g., 0.05) for the transition relationship 1303.

Referring to FIG. 13, the electronic device 100 may set a transition relationship 1304 from the storage node (e.g., Set: has_greeted) to an output node (e.g., User: Greeting) and a probability value (e.g., 1) for the transition relationship 1304.

Referring to FIG. 13, the electronic device 100 may set a transition relationship 1305 from the output node (e.g., User: Greeting) to the switch node (e.g., Switch: has greeted) and a probability value (e.g., 0.5) for the transition relationship 1305.

Referring to FIG. 13, the electronic device 100 may set a transition relationship 1306 from the branch node (e.g., True) to an output node (e.g., Assistant: GreetingAgain) and a probability value (e.g., 0.00001) for the transition relationship 1306.

Referring to FIG. 13, the electronic device 100 may set a transition relationship 1307 from a branch node (e.g., False) to a void node (e.g., Void: Final) and a probability value (e.g., 0.999) for the transition relationship 1307.

According to an embodiment, a transition relationship from a switch node to a branch node may not have a probability value.

According to an embodiment, the node flow may include at least one output node for generating prompt data corresponding to a virtual user message and at least one output node for generating completion data corresponding to a virtual agent message. For example, referring to FIG. 13, the node flow may include a first output node 1330 for generating prompt data corresponding to a virtual user message, a second output node 1340 for generating completion data corresponding to a virtual first agent message, and a third output node 1350 for generating completion data corresponding to a virtual second agent message. Meanwhile, the user message refers to a message obtained from a user, and the agent message refers to a message generated by inputting the user message into the large language model and processing it as an answer to the user message, which is output by an intelligent agent (or intelligent assistant) linked with the large language model. The electronic device 100 according to the present disclosure can automatically generate a large amount of virtual user messages and virtual agent messages using the node flow without directly receiving training user messages and training agent messages from the user.

According to various embodiments, the electronic device 100 (e.g., the processor 120 of FIG. 1) may set variable-related values for each of the nodes.

According to an embodiment, the electronic device 100 may obtain a storage variable and candidate storage variable values from the user as variable-related values for the storage node. For example, referring to FIG. 13, the electronic device 100 may obtain a storage variable (e.g., name) and candidate storage variable values (e.g., John, Karl, Alice, Alex) from the user for the storage node 1310. According to an embodiment, the electronic device 100 may set a probability value for each candidate storage variable value to be selected according to user input.

According to an embodiment, the electronic device 100 may obtain a condition variable from the user as a variable-related value for the switch node. For example, referring to FIG. 13, the electronic device 100 may obtain a condition variable (e.g., has_greeted) from the user for the switch node 1320.

According to an embodiment, the electronic device 100 may obtain a candidate state value for the condition variable of the switch node 1320 from the user as a variable-related value for the branch node. For example, referring to FIG. 13, the electronic device 100 may obtain a candidate state value (e.g., True) of the condition variable (e.g., has_greeted) from the user for the branch node 1321.

According to an embodiment, the electronic device 100 may obtain an output variable and candidate output variable values from the user as variable-related values for the output node. For example, referring to FIG. 13, the electronic device 100 may obtain an output variable (e.g., User: Greeting) and candidate output variable values (e.g., Hi, hi, Hello, hello) from the user for the output node 1330. According to an embodiment, the electronic device 100 may set a probability value for each candidate output variable value to be selected according to user input.

According to an embodiment, in setting the transition relationship and the variable-related values, the electronic device 100 may freely perform these operations regardless of the order. For example, the electronic device 100 may set variable-related values for each node after setting the transition relationships between nodes, or may set the transition relationships after setting the variable-related values.

In operation 1105, according to various embodiments, the electronic device 100 (e.g., the processor 120 of FIG. 1) may generate training data according to a result of executing the node flow in response to a request to generate the training data.

According to an embodiment, after setting of the transition relationships between nodes and the variable-related values for each node in the node flow is completed, the electronic device 100 may obtain the request to generate training data (i.e., a request to execute the node flow) from the user and generate the training data according to the result of executing the node flow in response to the request. For example, starting from the start node, the electronic device 100 may identify a result value of an executed node while proceeding (moving) to a next node according to the transition probability set for each transition relationship, and after executing through the last output node to the end node, the training data may be generated based on the execution result values of each node.

According to an embodiment, as the request to generate training data, the electronic device 100 may obtain the number of training data entries to be generated from the user. For example, referring to FIG. 14, when requested to generate 10 training data entries by the user, the electronic device 100 may generate 10 training data entries, where a first training data entry may represent [{“type”: “user”, “name”: “Greeting”, “content”: “hello”}, {“type”: “assistant”, “name”: “Greeting”, “content”: “Hi!”}]. As another example, the electronic device 100 may generate 100 training data entries when requested to generate 100 training data entries.

According to an embodiment, each training data entry may include prompt data corresponding to a virtual user message and completion data corresponding to a virtual agent message. According to an embodiment, following execution of the node flow, the electronic device 100 may output a type, an output variable (name), and content (i.e., a value selected from the candidate output variable values) of the output node corresponding to each of the prompt data and the completion data of the training data. For example, referring to FIG. 14, in the first training data entry, the prompt data may be {“type”: “user”, “name”: “Greeting”, “content”: “hello”} and the completion data may be {“type”: “assistant”, “name”: “Greeting”, “content”: “Hi!”}.

According to an embodiment, when a specific storage variable is included in the candidate output variable value, following execution of the node flow, the electronic device 100 may generate training data using a candidate output variable value that includes a candidate storage variable value selected for the specific storage variable. For example, referring to FIG. 12, when a specific storage variable (e.g., name) is included in a candidate output variable value (e.g., “Hi again! I'm {name}”.) of an output node object 1220, following execution of the node flow, the electronic device 100 may generate training data using the candidate output variable value into which a candidate storage variable value (e.g., Alex) selected for the specific storage variable is included.

According to an embodiment, the electronic device 100 may generate training data in a JSON (JavaScript Object Notation) structured format. The JSON format is merely one example and is not limited thereto; training data may be generated in various formats easily realizable by those skilled in the art. For example, the training data may be converted into a file form such as XML (extensible Markup Language), CSV (Comma-Separated Values), or TXT and then stored.

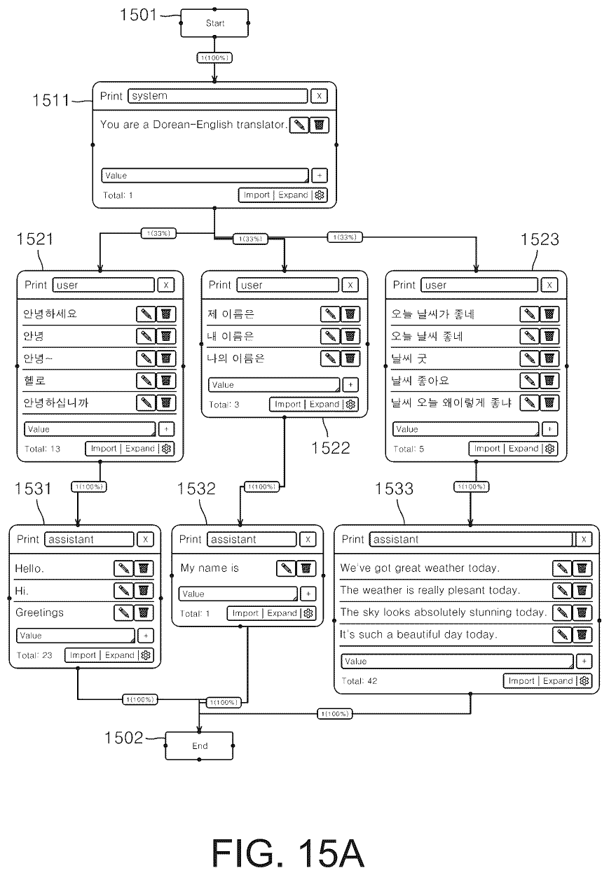

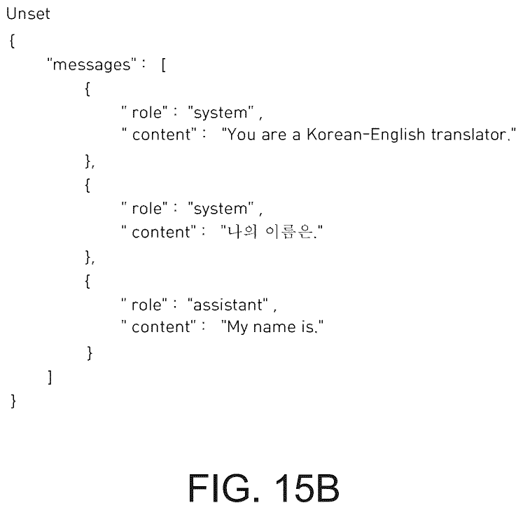

FIG. 15A is a diagram illustrating a node flow object for generating training data for a translation LLM according to various embodiments.

FIG. 15B is a diagram illustrating an example of a training data entry for a translation LLM generated by the node flow object of FIG. 15A according to various embodiments.

According to various embodiments, an electronic device 100 (e.g., a processor 120 of FIG. 1) may receive a user input for creating at least one node. According to an embodiment, to generate training data for a translation Large Language Model (LLM), the electronic device 100 may create at least one of an output node object for generating a system message, an output node object for generating a virtual user message as prompt data, or an output node object for generating a virtual agent message as completion data, based on a user input. For example, referring to FIG. 15A, the electronic device 100 may create a start node object 1501, a first output node object 1511 for generating a system message, 2-1 to 2-3 output node objects 1521, 1522, and 1523 for generating virtual user messages, 3-1 to 3-3 output node objects 1531, 1532, and 1533 for generating virtual agent messages, and an end node object 1502, according to user inputs.

According to an embodiment, a virtual user message serving as the training data for the translation LLM may refer to an original message to be translated, and a virtual agent message may refer to a translated message obtained by translating the original message.

According to an embodiment, each of the output node objects for generating the virtual user message and/or the virtual agent message may be linked with an LLM trained to output similar expressions, and the electronic device 100 may expand candidate output variable values by a predetermined number using the LLM in response to a user request. For example, if only two pieces of data (e.g., “Hello” and “Hi”) are input as candidate output variable values in an output node object 1521 for generating a virtual user message, the electronic device 100 may input these two pieces of data into the LLM as an expansion button (Expand) is selected by the user to expand similar data (e.g., “Hello~”, “Greetings”, “How do you do”, etc.) by a predetermined number (e.g., 11) and input the same into the output node object 1521. Here, the predetermined number may be freely changed and set by the user.

According to an embodiment, the electronic device 100 may receive a user input for setting a transition relationship and a transition probability between at least two nodes. For example, referring to FIG. 15A, the electronic device 100 may set transition relationships and transition probabilities (e.g., 33% each) from the first output node object 1511 to the 2-1 to 2-3 output node objects 1521, 1522, and 1523 according to user inputs. As another example, referring to FIG. 15A, the electronic device 100 may set transition relationships and transition probabilities (e.g., 100% each) from the 2-1 to 2-3 output node objects 1521, 1522, and 1523 to the 3-1 to 3-3 output node objects 1531, 1532, and 1533. As yet another example, the electronic device 100 may set transition relationships and transition probabilities (e.g., 100% each) from the 3-1 to 3-3 output node objects 1531, 1532, and 1533 to the end node object 1502 according to user inputs.

According to an embodiment, the contents regarding the training data of the conversational LLM described in FIGS. 11 to 14 may be applied to the training data of the translation LLM, and conversely, the contents regarding the training data of the translation LLM may also be applied to the training data of the conversational LLM.

According to an embodiment, referring to FIG. 15B, the output node object for generating a virtual user message in the training data of the translation LLM may be configured to output one piece of prompt data (e.g., an original message) and one piece of completion data (e.g., a translated message) according to the execution of the node flow object. Accordingly, the electronic device 100 may generate a training data entry as shown in FIG. 15B as a result of executing the node flow of FIG. 15A.

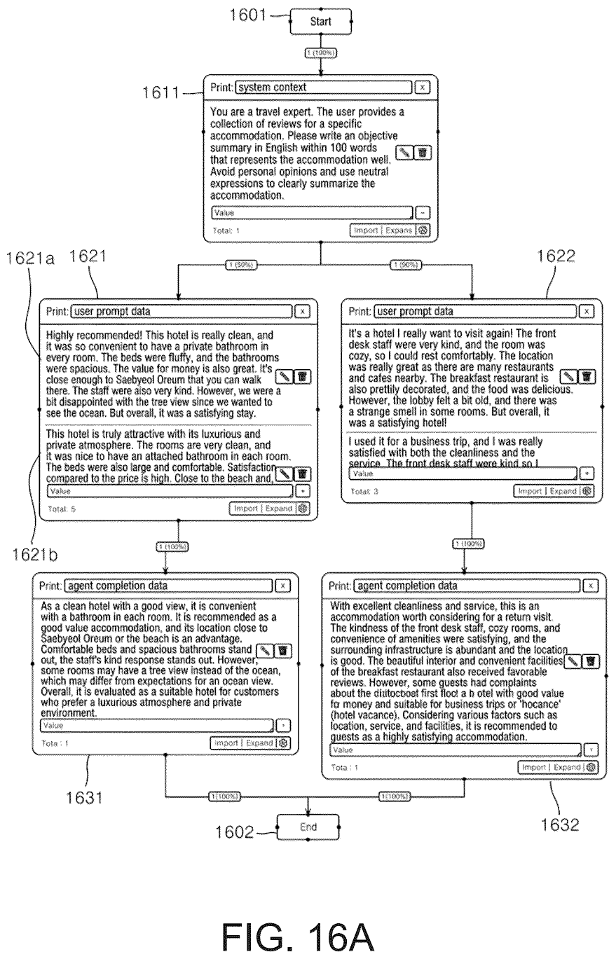

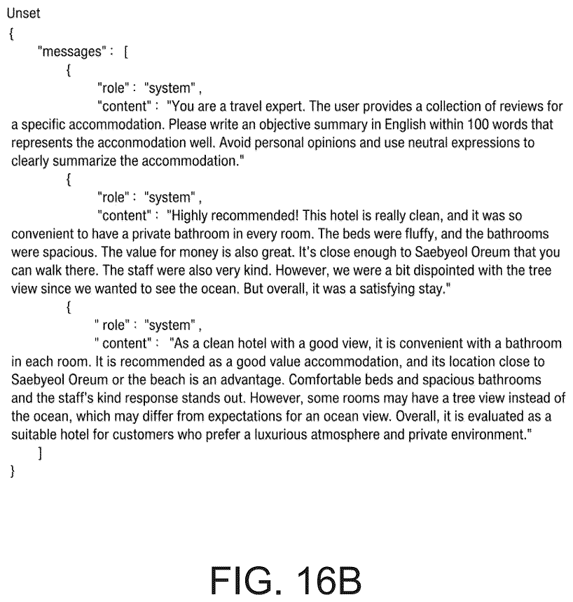

FIG. 16A is a diagram illustrating a node flow object for generating training data for a summarization LLM according to various embodiments.

FIG. 16B is a diagram illustrating an example of a training data entry for a summarization LLM generated by the node flow object of FIG. 16A according to various embodiments.

According to various embodiments, an electronic device 100 (e.g., a processor 120 of FIG. 1) may receive a user input for creating at least one node. According to an embodiment, to generate training data for a summarization Large Language Model (LLM), the electronic device 100 may create at least one of: an output node object for generating a system message, an output node object for generating a virtual user message as prompt data, or an output node object for generating a virtual agent message as completion data, based on a user input. For example, referring to FIG. 16A, the electronic device 100 may create a start node object 1601, a first output node object 1611 for generating a system message, 2-1 to 2-2 output node objects 1621, 1622 for generating virtual user messages, 3-1 to 3-2 output node objects 1631, 1632 for generating virtual agent messages, and an end node object 1602 according to user inputs.

According to an embodiment, the virtual user message in the training data for the summarization LLM may refer to an original message subject to summarization, and the virtual agent message may refer to a summarized message that summarizes the original message.

According to an embodiment, each of the output node objects for generating the virtual user message and/or the virtual agent message may be linked to an LLM trained to output new messages according to a predetermined criterion (e.g., an operation of outputting the same content in a different manner), and the electronic device 100 may expand candidate output variable values by a predetermined number using the LLM in response to a user request. The aforementioned predetermined criterion (e.g., an operation of outputting the same content in a different manner) may include various operations such as: changing a sentence structure or arrangement while maintaining the content, changing a particle of a sentence while maintaining a core expression of the sentence, or adding or removing an interjection. For example, when only two pieces of data 1621a, 1621b are input as candidate output variable values in an output node object 1621 for generating a virtual user message, the electronic device 100 may input the two pieces of data into the LLM as an expansion button (Expand) is selected by the user to expand them by a predetermined number (e.g., 3) of new data (e.g., new review messages) that have the same content but are written in a different manner, and input them to the output node object 1621. Here, the predetermined number may be freely changed and set by the user.

According to an embodiment, the electronic device 100 may receive a user input for setting a transition relationship and a transition probability between at least two nodes. For example, referring to FIG. 16A, the electronic device 100 may set transition relationships and transition probabilities (e.g., 50% each) from the first output node object 1611 to the 2-1 to 2-2 output node objects 1621, 1622 according to user inputs. As another example, referring to FIG. 16A, the electronic device 100 may set transition relationships and transition probabilities (e.g., 100% each) from the 2-1 to 2-2 output node objects 1621, 1622 to the 3-1 to 3-2 output node objects 1631, 1632 according to user inputs. As yet another example, the electronic device 100 may set transition relationships and transition probabilities (e.g., 100% each) from the 3-1 to 3-2 output node objects 1631, 1632 to the end node object 1602 according to user inputs.

According to an embodiment, the contents of the training data for the conversational LLM described in FIGS. 11 to 14 may be applied to the training data for the summarization LLM, and conversely, the contents of the training data for the summarization LLM may also be applied to the training data for the conversational LLM.

According to an embodiment, referring to FIG. 16B, the output node object for generating a virtual user message in the training data for the summarization LLM may be configured to output one piece of prompt data (e.g., an original message) and one piece of completion data (e.g., a summarized message) according to the execution of the node flow object. Accordingly, as a result of executing the node flow of FIG. 16A, the electronic device 100 may generate a training data entry as shown in FIG. 16B.

According to various embodiments, a server for providing relevant context information in real-time while transmitting and receiving chat messages with a user device using an intelligent agent may include a communication module and a processor. The processor may be configured to execute instructions to cause the user device to display at least one chat message transmitted and received with a large language model (LLM) based intelligent agent on a chat window screen, in response to identifying first context information related to a travel itinerary from a first user message received from the user device, cause the user device to display the first context information on a travel itinerary display window screen, and output a first agent message including at least a portion of the first context information and first search result information corresponding to a specific query to the chat window screen through the intelligent agent, while causing the user device to display at least one first object for second context information corresponding to the first search result information on a context display window screen.

According to various embodiments, the processor may be configured to identify, as the first context information, at least one of travel region information, travel date information, or travel personnel information from the first user message.

According to various embodiments, the processor may be configured to obtain the first search result information from a database linked with the large language model by using at least a portion of the first context information and the specific query, and identify, as the second context information, at least one of location information, web link information, or app link information corresponding to the first search result information.

According to various embodiments, the processor may be configured to further execute instructions to in response to identifying third context information related to a travel place condition from a second user message received from the user device, identify second search result information determined by the intelligent agent based on at least a portion of the first context information, the third context information, and the specific query, and output a second agent message including the second search result information as an answer message for the second user message to the chat window screen, while causing the user device to display at least one second object for fourth context information corresponding to the second search result information on the context display window screen.

According to various embodiments, the processor may be configured to, in response to identifying the third context information, cause the user device to display the third context information on the travel itinerary display window screen.

According to various embodiments, the processor may be configured to in response to identifying another specific query from a third user message received from the user device, identify at least one piece of context information and third search result information corresponding to the another specific query, and output a third agent message including the third search result information as an answer message for the third user message to the chat window screen, while causing the user device to display at least one third object for fifth context information corresponding to the third search result information on the context display window screen.

According to various embodiments, an operation method of a server for providing relevant context information in real-time while transmitting and receiving chat messages with a user device using an intelligent agent comprises

According to various embodiments, a method of a server for providing relevant context information in real-time while transmitting and receiving chat messages with a user device using an intelligent agent may include causing the user device to display at least one chat message transmitted and received with a large language model (LLM) based intelligent agent on a chat window screen, causing, in response to identifying first context information related to a travel itinerary from a first user message received from the user device, the user device to display the first context information on a travel itinerary display window screen, and outputting a first agent message including at least a portion of the first context information and first search result information corresponding to a specific query to the chat window screen through the intelligent agent, while causing the user device to display at least one first object for second context information corresponding to the first search result information on a context display window screen.

According to various embodiments, a computer program product may include one or more programs configured to be executed by one or more processors of a computer system. The one or more programs may include instructions for causing the user device to display at least one chat message transmitted and received with a large language model (LLM) based intelligent agent on a chat window screen, in response to identifying first context information related to a travel itinerary from a first user message received from the user device, causing the user device to display the first context information on a travel itinerary display window screen, and outputting a first agent message including at least a portion of the first context information and first search result information corresponding to a specific query to the chat window screen through the intelligent agent, while causing the user device to display at least one first object for second context information corresponding to the first search result information on a context display window screen.

According to various embodiments, a server for providing a package travel product while transmitting and receiving chat messages with a user device through an intelligent agent may include a communication module and a processor. The processor may be configured to execute instructions to cause the user device to display at least one chat message transmitted to and received from an intelligent agent based on a large language model (LLM) on a chat window screen, identify a request for generating a package travel product, which is a combination of at least two travel products, from a user message received from the user device, determine price information of the package travel product by using first context information related to a travel itinerary, and cause the user device to display an agent message including the price information of the package travel product on the chat window screen through the intelligent agent.

According to various embodiments, the first context information may include travel region information, travel date information, and travel personnel information, and the processor may be configured to determine the price information of the package travel product by using the travel date information and the travel personnel information.

According to various embodiments, the processor may be configured to identify a discount weight corresponding to a type of the at least two travel products, calculate cost information by applying the travel date information and the travel personnel information to price information of the at least two travel products, calculate discount price information by applying a discount weight for each type to the price information of the at least two travel products, and calculate the price information of the package travel product by summing the cost information and the discount price information.

According to various embodiments, each of the types of the at least two travel products may include at least one of transportation information, accommodation information, tourist spot information, restaurant information, tour information, or ticket information.

According to various embodiments, the server may further include a memory storing a table in which types of travel products are divided into a plurality of classification systems and discount weights are matched for each of the plurality of classification systems, and the processor may be configured to identify a discount weight corresponding to a classification of the at least two travel products from the table.

According to various embodiments, the processor may be configured to request corresponding information through the intelligent agent if travel date information or travel personnel information does not exist in the first context information after identifying the request for generating the package travel product.

According to various embodiments, a method of a server for providing a package travel product while transmitting and receiving chat messages with a user device through an intelligent agent may include: causing the user device to display at least one chat message transmitted to and received from an intelligent agent based on a large language model (LLM) on a chat window screen; identifying a request for generating a package travel product, which is a combination of at least two travel products, from a user message received from the user device; determining price information of the package travel product by using first context information related to a travel itinerary; and causing the user device to display an agent message including the price information of the package travel product on the chat window screen through the intelligent agent.

According to various embodiments, a computer program product may include one or more programs configured to be executed by one or more processors of a computer system. The one or more programs may include instructions for: causing a user device to display at least one chat message transmitted to and received from an intelligent agent based on a large language model (LLM) on a chat window screen; identifying a request for generating a package travel product, which is a combination of at least two travel products, from a user message received from the user device; determining price information of the package travel product by using first context information related to a travel itinerary; and causing the user device to display an agent message including the price information of the package travel product on the chat window screen through the intelligent agent.

According to various embodiments, an electronic device for generating training data to be used for training a large language model may include a display and a processor. The processor may be configured to create at least one node among a storage node, a switch node, a branch node, and an output node by using an application for generating the training data, generate a node flow in which transition relationships between the at least one node and variable-related values for each of the nodes are set, and generate, in response to a request for generating the training data, the training data according to a result of executing the node flow, wherein the training data may include prompt data corresponding to a virtual user message and completion data corresponding to a virtual agent message.

According to various embodiments, the at least one node and the node flow may be implemented in the form of a graphic user interface, and the node flow may include at least one output node for generating the prompt data and at least one output node for generating the completion data.

According to various embodiments, the processor may be configured to obtain a storage variable and candidate storage variable values as the variable-related values for the storage node, obtain a condition variable as the variable-related value for the switch node, obtain a candidate state value of the condition variable as the variable-related value for the branch node, and obtain an output variable and candidate output variable values as the variable-related values for the output node.

According to various embodiments, the processor may be configured to generate the training data using a candidate output variable value into which a candidate storage variable value selected for a specific storage variable is included, when the specific storage variable is included in the candidate output variable value, following execution of the node flow.

According to various embodiments, the processor may be configured to output a type, an output variable (name), and content for each of the prompt data and the completion data, following execution of the node flow.

According to various embodiments, the processor may be configured to obtain the number of the training data entries to be generated from a user as the request for generating the training data, and the training data may be generated in a JSON structured format.

According to various embodiments, an operation method of an electronic device for generating training data to be used for training a large language model may include: creating at least one node among a storage node, a switch node, a branch node, and an output node by using an application for generating the training data; generating a node flow in which transition relationships between the at least one node and variable-related values for each of the nodes are set; and generating, in response to a request for generating the training data, the training data according to a result of executing the node flow, wherein the training data may include prompt data corresponding to a virtual user message and completion data corresponding to a virtual agent message.

According to various embodiments, a computer program product may include one or more programs configured to be executed by one or more processors of a computer system. The one or more programs may include instructions for: creating at least one node among a storage node, a switch node, a branch node, and an output node by using an application for generating training data to be used for training a large language model; generating a node flow in which transition relationships between the at least one node and variable-related values for each of the nodes are set; and generating, in response to a request for generating the training data, the training data according to a result of executing the node flow, wherein the training data may include prompt data corresponding to a virtual user message and completion data corresponding to a virtual agent message.

The term “module” or “~ unit” used in this document includes a unit configured of hardware, software, or firmware, and may be used interchangeably with terms, for example, logic, logic block, part, and circuit. The “module” or “~ unit” may be an integrally configured component, or a minimum unit or a part thereof that performs one or more functions. The “module” or “~ unit” may be implemented mechanically or electronically, and include, for example, an application-specific integrated circuit (ASIC) chip, field-programmable gate arrays (FPGAs), or a programmable logic device known or to be developed in the future to perform certain operations, and may be executed by the processor 120. At least some of devices (e.g., modules or functions thereof) or methods (e.g., operations) according to various embodiments may be implemented as instructions stored in a computer-readable storage medium (e.g., the memory 130) in the form of a program module. When the instructions are executed by a processor (e.g., the processor 120), the processor may perform a function corresponding to the instructions. The computer-readable recording medium may include a hard disk, a floppy disk, a magnetic medium (e.g., a magnetic tape), an optical recording medium (e.g., a CD-ROM, a DVD), a magneto-optical medium (e.g., a floptical disk), a built-in memory, and the like. The instructions may include codes generated by a compiler or codes executable by an interpreter. A module or a program module according to various embodiments may include at least one or more of the components described above, omit some of the components, or further include other components. Operations performed by a module, a program module, or other components according to various embodiments may be executed sequentially, in parallel, repeatedly, or heuristically, or at least some of the operations may be executed in a different order or omitted, or other operations may be added.

In addition, the embodiments disclosed in this document are presented for the purpose of explanation and understanding of the disclosed technical contents, and do not limit the scope of the present disclosure. Accordingly, the scope of the present disclosure should be interpreted to include all modifications or various other embodiments based on the technical spirit of the present disclosure.

1. A server for providing relevant context information in real-time while transmitting and receiving chat messages with a user device using an intelligent agent, the server comprising:
a communication module; and
a processor,
wherein the processor is configured to execute instructions to:
cause the user device to display at least one chat message transmitted and received with a large language model (LLM) based intelligent agent on a chat window screen;
in response to identifying first context information related to a travel itinerary from a first user message received from the user device, cause the user device to display the first context information on a travel itinerary display window screen; and
output a first agent message including at least a portion of the first context information and first search result information corresponding to a specific query to the chat window screen through the intelligent agent, while causing the user device to display at least one first object for second context information corresponding to the first search result information on a context display window screen.

2. The server according to claim 1, wherein the processor is configured to identify, as the first context information, at least one of travel region information, travel date information, or travel personnel information from the first user message.

3. The server according to claim 1, wherein the processor is configured to:
obtain the first search result information from a database linked with the large language model by using at least a portion of the first context information and the specific query; and
identify, as the second context information, at least one of location information, web link information, or app link information corresponding to the first search result information.

4. The server according to claim 1, wherein the processor is configured to further execute instructions to:
in response to identifying third context information related to a travel place condition from a second user message received from the user device, identify second search result information determined by the intelligent agent based on at least a portion of the first context information, the third context information, and the specific query; and
output a second agent message including the second search result information as an answer message for the second user message to the chat window screen, while causing the user device to display at least one second object for fourth context information corresponding to the second search result information on the context display window screen.

5. The server according to claim 4, wherein the processor is configured to, in response to identifying the third context information, cause the user device to display the third context information on the travel itinerary display window screen.

6. The server according to claim 5, wherein the processor is configured to:
in response to identifying another specific query from a third user message received from the user device, identify at least one piece of context information and third search result information corresponding to the another specific query; and
output a third agent message including the third search result information as an answer message for the third user message to the chat window screen, while causing the user device to display at least one third object for fifth context information corresponding to the third search result information on the context display window screen.

7. A method of a server for providing relevant context information in real-time while transmitting and receiving chat messages with a user device using an intelligent agent, the method comprising:
causing the user device to display at least one chat message transmitted and received with a large language model (LLM) based intelligent agent on a chat window screen;
causing, in response to identifying first context information related to a travel itinerary from a first user message received from the user device, the user device to display the first context information on a travel itinerary display window screen; and
outputting a first agent message including at least a portion of the first context information and first search result information corresponding to a specific query to the chat window screen through the intelligent agent, while causing the user device to display at least one first object for second context information corresponding to the first search result information on a context display window screen.
